(19) United States
(12) Patent Application Publication
(10) Pub. No.: US 2023/0061899 A1
(43) Pub. Date: Mar. 2, 2023

(54) DYNAMIC ALLOCATION OF HUMAN RESOURCES FOR EFFICIENT PROJECT MANAGEMENT

(71) Applicants: Rangarajan Venkataraman, Bethlehem, PA (US); Latha Gopalan, Bethlehem, PA (US)

(72) Inventors: Rangarajan Venkataraman, Bethlehem, PA (US); Latha Gopalan, Bethlehem, PA (US)

(21) Appl. No.: 17/458,156

(22) Filed: Aug. 26, 2021

(51) Int. Cl. G06Q 10/06

(52) U.S. Cl. CPC G06Q 10/06312; G06Q 10/06313; G06Q 10/063112; G06Q 10/063116

(57) ABSTRACT

A web-based system solution, including process logic and data model, that allocates available resources to project tasks in a manner that ensures availability of specific resources with required skill sets to perform specific tasks at specific time periods in future when those tasks become due. The solution automates the creation and maintenance of realistic project plans linked at all times to resource availability, as an outcome of such resource allocations. Resource allocations are done to the entire set of future tasks across all projects in the organization in a coordinated manner. The system continually monitors changes to critical input parameters that could impact the demand or the availability of specific resources at specific time periods. The resource allocations are performed at a minimum at least once a day to incorporate the impact of changes in real time on resource availability and resulting project plans and resource loads, thus “dynamic”.

### CROSS-REFERENCE TO RELATED APPLICATIONS

This application claims prior from and the benefit of US Provisional Application No. 63/082,743 , filed Sep. 24, 2020 and herein incorporated by reference.

### TECHNICAL FIELD

The present invention relates to a methodology for dynamic allocation of human resources for project management and, more particularly, to a dynamic resource allocation based project management platform that is web based and easy to use without requiring extensive IT department resources to implement or support.

### BACKGROUND OF THE INVENTION

This invention addresses a fundamental need in most organizations, which is to close the disconnect between plans and resource availability. This disconnect manifests in the form of lack of time for people to do their jobs. Plans assume resources will be available when tasks become due. This assumption is often wrong, Resources are overbooked during certain time periods, causing unexpected delays in execution. While overall workload may be within capacity, during certain periods of time, demand exceeds resource capacity of individuals and groups, causing unexpected delays and a chain reaction of events. It is not easy to forecast the delays with spreadsheet management of projects. Project Managers and Senior Management are handicapped by lack of realistic and real time views of project timetable, or insights on when, where, and what specific resources to add, to deliver projects on time. Countless hours are wasted in reacting to delays. Employee morale is impacted negatively from not being able to keep up with the demands.

Besides resource conflicts, unexpected events may require resources to be diverted to resolving some urgent issues. The diversion of resources will impact resource availability for planned activities. However, plans are not revised to capture the impact of such events properly, putting pressure on employees to catch up on the plans. Also, daily changes and new developments in a company impact resource availability now and in future, in complex ways, due to dependencies of tasks on other task completions, and dependencies of tasks on specific resources. When plans do not reflect the impact of these changes, unexpected delays can result. When an organization reacts to delays, it results in more non-value-add activities, cost overruns, last minute ad hoc actions, and increased risk for quality and safety issues. The reactionary steps will have their own chain reaction impact on future task completions and the pattern repeats. Reactionary project management drags down the performance of a company.

Plans must be integrally linked to resource availability at all times. Plans must be based on actual and specific resource allocations devoid of conflicts. Resource allocations must be continually updated to keep up with the changes in real time. It is impossible to do this manually.

### SUMMARY OF THE INVENTION

The present invention addresses this need with a dynamic resource allocation based project management platform that is web based and easy to use. The solution does not require extensive IT department resources to implement or support.

The inventive solution prevents double booking of resources at all times, thus providing the time for people to complete their task. The solution also ensures that the defined daily workhour capacity for project tasks is not exceeded (accounting for daily standard work), and no work is planned or forecasted on defined weekends and holidays. The solution provides clear insights to management on resource needs, resource utilization, and status of all assigned activities and projects. The principles of the present invention as described in detail below allow for the creation of realistic project plans in real time, based on adjusted resource allocations to future tasks that reflect impact of everyday changes in the organization. Each day, every overdue task will be accounted for automatically, and its influence seen on the new set of future resource allocations and resulting project plans, reflecting the reality of the impact of delays. Company, group, and individual events that take away resources at specific periods of time are reflected in the dynamically adjusted resource allocations and project plans. The dynamic resource allocations based project management can include allocation of physical resources, such as equipment and facilities, and resources at suppliers, collaborators, and customers. The solution can take information on cost inputs to calculate dynamic resource allocations based project costs.

A primary objective of the present invention is to provide an easy-to-use, computer-based system, and method, to always link resource availability integrally to project plans, thus avoiding the problems, described earlier. In order to achieve this and other objectives, the invention provides a web-based platform and computer algorithm to perform dynamic resource allocations to all project tasks in real time.

In one exemplary embodiment, the present invention provides a method to develop realistic project plans based on resource availability. The method consists of the following steps: providing a computer-readable database which contains data on all projects including start date, desired completion date and priority; data on all tasks including project identification, duration, group owners, plan start and end dates, forecast start and end dates, effort hours, precursor tasks (if any) and slack; data on resources for each group; data on company, group and individual events impacting resource availability including start and return dates for those events; using the computer algorithm to update forecast end dates for open tasks to be not earlier than the present day, update forecast start dates on future tasks to be not earlier than the present day, order and sort tasks requiring resource assignments by project priority (ascending by priority number), forecasted start date (ascending) and slack available (ascending), and doing the following for each task: deriving resource choices from group ownership, analyzing and eliminating resource choices conflicting with other task assignments ahead in the queue, eliminating resource choices that have not yet joined the company in time to start the task, eliminating resource choices leaving the company before start of the task or during the duration of the task, eliminating resource choices conflicting with company, group or individual events, and for each of the remaining resources without a conflict who can be assigned for this task, evaluating resource availability after task start and resulting delays in completing the task, evaluating impact on delaying future tasks assigned to a team that a resource belongs to, selecting a resource with minimum combined impact on current and future tasks, or shifting the start of task in time till a resource will become available, along with shifting in time of other tasks dependent on this task, and repeating this process iteratively, till a resource choice is identified for every task in the stack of tasks to be assigned resources, updating the database with forecasted start and end dates, and selected resource for each of the tasks, updating project completion date and slack based on completion dates of the tasks belonging to each project. For the purposes of the description of the present invention, this method will be referred to as “performing dynamic resource allocations to project tasks”.

The present invention provides a method to automatically and frequently adjust resource allocations and project plans linked to resource availability, to account for recent changes to resources, projects, tasks, target dates, company, group and personal events that can impact resource availability in specific periods of time. The method consists of the following steps: using web based forms to record in a computer database, changes to members of any group, changes to any project status, project priority, start dates or target dates, changes to any task status, duration, ownership, dependencies on other tasks, additions and deletions of tasks to any project, changes or addition of company events, group events, or personal events, and the start and end dates for those events, and the group or resource that the event impacts, in a computer-readable database, performing dynamic resource allocations to project tasks at least once a day, at a minimum, to reflect impact of additions and changes to all events that could affect resource availability now and in future in complex interconnected ways through task interdependencies and task dependencies on specific groups.

In an exemplary embodiment, the inventive method provides a method to structure resource levels to meet project needs in any given time period. The method consists of the following steps: performing dynamic resource allocations to project tasks; using computer-based code for filtering tasks with forecasted and planned activity in a given time period, computing the average and peak plan resource loads by month from planned tasks in this time period, average and peak forecasted resource loads by month from the forecasted tasks in this time period, based on dynamic resource allocation, as well as aggregated statistics for the time period. The plan demand and forecasted load can be in person-hours or # of persons. The plan demand and forecasted load is provided for each functional group. Resource utilization as a percentage of capacity is calculated for each of the months in the time period, as well as for the entire time period, based on the forecasted activity from dynamic resource allocations. The capacity of the group is determined by the number of members available in each group. The plan demand numbers in combination with resource utilization percentages, projected project completion dates, and available project slacks is used to make decisions on staffing levels in different groups as follows: if peak demand on a group exceeds the capacity of the group in a given time period, resulting in some project delay, but all projects still have positive slack, the number of resources in the group may be adequate; if the peak demand on a group exceeds the capacity of the group in a given time period, resulting in some projects being delayed beyond target completion dates, resources may be added to that specific functional group permanently or for specific months within the time period where the demand exceeds capacity causing the project delays; if forecasted resource utilization percentage is below 25% of capacity (or another suitable target percentage established for decisions), resources in that group may be reduced to raise the resource utilizations to 50% of capacity (or another suitable target percentage established for decisions).

The present invention provides a method to tailor input parameters to achieve different scenarios of resource allocations that yield different project plans to meet desired objectives.

In one embodiment, the method consists of the following steps: selecting a desired scenario — some example scenarios include — ensuring critical projects are completed on time while accepting delays to other projects relative to desired completion dates, maximizing resource utilization across existing resources while accepting delays in some projects, minimizing project delays relative to an aggressive plan even if it means adding resources where required to meet the plan, level loading the demand on resources by staggering project starts, as long as projects are completed within a given time period; making the required adjustments to input parameters as follows: to ensure certain projects are completed on time relative to plan, they are assigned the highest priority, a value of 1, so that resources are first allocated to those projects; to maximize resource utilization, all projects are started as early as possible or at the start of calendar year for example, and each project is assigned a unique priority starting with 1 for the earliest starting project and 2 for the next earliest and so on; if project delays have to be minimized relative to plan, all projects are started at the earliest with unique priority as described above, required number of resources are added to specific groups in specific time periods as highlighted by dynamic resource allocations, to eliminate forecasted delays; if plans provide for staggering of start dates, and a level loading of resources is desired, then projects are staggered in time based on the resource utilization outcomes of dynamic resource allocations; performing dynamic resource allocations to project tasks; using computer-based code for filtering tasks with forecasted and planned activity in a given time period, computing the average and peak plan resource loads by month from the planned tasks in this time period, average and peak forecasted resource loads by month from the forecasted tasks in this time period based on dynamic resource allocation, as well as aggregated statistics for the time period, and based on the outcome, further adjusting the input parameters, if required, and performing dynamic resource allocations for project tasks again, and repeating the last two steps till the desired planning scenario is achieved.

The present invention also provides a method to automatically detect and update forecasted completion dates on overdue tasks, and adjust resource allocations for future tasks based on the impact of the delays on timing of future tasks. The method consists of the following steps: performing dynamic resource allocations to project tasks at least once a day, at a minimum, to reflect impact of delays from overdue tasks on resource allocations and on task and project completion dates.

It is to be understood that the term “project” as used throughout the following discussion can be basically defined as a collection of “tasks”. In one example, the collection of tasks can be performed by one or more functional groups, to accomplish a specific business objective, for example but not limited to, designing, developing and launching new products, approving and onboarding a supplier, qualifying production and assembly processes, facilities or products, constructing buildings, highways, onboarding a customer and the like. Additionally, the term “project” can be used in accordance with the purposes of the present invention to describe a collection of “service request tasks” including, but not limited to, lab and testing services, production support, customer support, supplier support, maintenance work, facilities management, analysis requests of various kinds, setting up specific systems or computer programs. Indeed, it is to be understood that the principles of the present invention can be directed to a different collection of tasks for any suitable purpose others than those specifically identified above.

Regardless of the specific application, each “project” has a defined priority to it, a start date, and a desired target date for completion. Specifically, all tasks within a project also need to be completed and closed for a given project to be completed. New tasks can be added to a project and existing tasks can be deleted, and existing tasks can be modified as well. Various ones of the critical attributes of a project, as well as a task within a project, are shown in FIGS. 7 and 9, respectively. More attributes may be added to a project record or task record, as required.

Other and further details of the inventive dynamic resource allocation procedure will become apparent during the course of the following discussion and by references to the accompanying drawings.

### BRIEF DESCRIPTION OF THE DRAWINGS

Referring now to the drawings, where like numerals represent like elements in several views:

FIG. 1 is a block diagram representation of a primary objective of the present invention;

FIG. 2 is an example process template plan used to generate project plans for the purpose of illustrating the application of the present invention;

FIG. 3 is a block diagram of a computer web based system for Dynamic Resource Allocations to Project Tasks according to a preferred embodiment of the present invention;

FIG. 4 is a block diagram of the Application performing dynamic resource allocations to Project Tasks according to a preferred embodiment of the present invention;

FIG. 5 is a block diagram showing the transactions managed in the Resource Management Module of a computer web based system for Dynamic Resource Allocations to Project Tasks according to a preferred embodiment of the present invention;

FIG. 6 is a block diagram showing the transactions managed in the Project Management Module of a computer web based system for Dynamic Resource Allocations to Project Tasks according to a preferred embodiment of the present invention;

FIG. 7 lists some of the critical attributes of a “Project” record in the web based system for Dynamic Resource Allocations to Project Tasks according to a preferred embodiment of the present invention;

FIG. 8 is a block diagram showing the transactions managed in the Task Management Module of a computer web based system for Dynamic Resource Allocations to Project Tasks according to a preferred embodiment of the present invention;

FIG. 9 lists some of the critical attributes of a “Task” record in the web based system for Dynamic Resource Allocations to Project Tasks according to a preferred embodiment of the present invention;

FIG. 10 is a block diagram showing the transactions managed in the Time Based Events Management Module of a computer web based system for Dynamic Resource Allocations to Project Tasks according to a preferred embodiment of the present invention;

FIG. 11 is a block diagram showing the transactions managed in the Process Template Module of a computer web based system for Dynamic Resource Allocations to Project Tasks according to a preferred embodiment of the present invention;

FIG. 12A is a flow chart of steps involved in a preferred implementation of Dynamic Resource Allocations to Project Tasks;

FIG. 12B is a flow chart of steps involved in a preferred implementation of Dynamic Resource Allocations to Project Tasks;

FIG. 12C is a flow chart of steps involved in a preferred implementation of Dynamic Resource Allocations to Project Tasks;

FIG. 13 is an example organization used for the purposes of illustrating the application of the present invention, with nine functional groups, and each group having five members;

FIG. 14 is a project dashboard showing projected completion dates and project slack for nine sample projects resulting from the application of the present invention, to the “complete projects early” base scenario, with the nine projects based on the process template plan shown in FIG. 2;

FIG. 15 is a project plan linked to resource availability for one of the projects with lower priority, resulting from the application of the present invention to the “complete projects early” scenario;

FIG. 16 illustrates an exemplary critical path through a project plan linked to resource availability, resulting from the application of the present invention to the “complete projects early” scenario, highlighting the impact of resource availability on start of specific tasks;

FIG. 17 shows the project load on all the functional groups, in a given time period, resulting from the application of the present invention to the “complete projects early” scenario;

FIG. 18 shows a chart of tasks assigned to each of the resources in a functional group, in a given time period, resulting from the application of the present invention to the “complete projects early” scenario;

FIG. 19 shows the project load and resource utilization on a functional group, by month, in a given time period, resulting from the application of the present invention to the “complete projects early” scenario;

FIG. 20 is a project dashboard showing projected completion dates and project slack for nine sample projects resulting from the application of the present invention to “complete projects early with deferred project starts” scenario, where four of the nine projects were started 75 business days later, compared to the “complete projects early” base scenario;

FIG. 21 illustrates an exemplary critical path through a project plan linked to resource availability, resulting from application of the present invention to “complete projects early with deferred project starts” scenario;

FIG. 22 shows a planning scenario with reduced resource levels in some of the nine functional groups, shown in FIG. 13;

FIG. 23 is a project dashboard showing projected completion dates and project slack for nine sample projects resulting from the application of the present invention to “reduced staff + deferred project starts” scenario;

FIG. 24 shows the project load on all the functional groups, in a given time period, resulting from the application of the present invention to “reduced staff + deferred project starts” scenario;

FIG. 25 shows the project load for all resources, in terms of number of days of work, in a given time period from the application of the present invention to “reduced staff + deferred project starts” scenario;

FIG. 26 shows a chart of tasks assigned to each of the resources in a functional group, in a given time period, resulting from the application of the present invention to “reduced staff + deferred project starts” scenario;

FIG. 27 shows the project load and resource utilization on a functional group, by month, in a given time period, resulting from the application of the present invention to “reduced staff + deferred project starts” scenario;

FIG. 28 shows a chart of tasks assigned to each of the resources in a functional group, in a given time period, resulting from the application of the present invention to “reduced staff + deferred project starts” scenario;

FIG. 29 shows a list of recorded time-based events that impact resource availability, in a given time period, as an input to the application of the present invention;

FIG. 30 is a project dashboard showing projected completion dates and project slack for nine sample projects resulting from the application of the present invention to “reduced staff + deferred project starts” scenario, with events impacting specific resource availability in specific periods as listed in FIG. 29;

FIG. 31 shows a chart of tasks assigned to each of the resources in a functional group, in a given time period, resulting from the application of the present invention to “reduced staff + deferred project starts” scenario, with and without events impacting specific resource availability in specific periods as listed in FIG. 29;

FIG. 32 shows a list of recorded time-based events that impact resource availability, including a marketing resource time off event, in a given time period, as an input to the application of the present invention;

FIG. 33 is a project dashboard showing projected completion dates and project slack for nine sample projects resulting from the application of the present invention to “reduced staff + deferred project starts” scenario, with events impacting specific resource availability in specific periods as shown in FIG. 32;

FIG. 34A is a project plan linked to resource availability for one of the projects with lower priority, resulting from the application of the present invention to “reduced staff + deferred project starts” scenario, with events impacting specific resource availability in specific periods as listed in FIG. 29;

FIG. 34B is a project plan linked to resource availability for one of the projects with lower priority, resulting from the application of the present invention to “reduced staff + deferred project starts” scenario, with events impacting specific resource availability in specific periods as listed in FIG. 32;

FIG. 35 illustrates the role of dependencies of tasks on other tasks and tasks on specific groups, while making a resource selection for a task in a low priority project, from the application of the present invention to “reduced staff + deferred project starts” scenario, with events impacting specific resource availability in specific periods as shown in FIG. 29;

FIG. 36 illustrates the impact of time off event and the role of dependencies of tasks on other tasks and tasks on specific groups, while making a resource selection for a task in a low priority project, from the application of the present invention to “reduced staff + deferred project starts” scenario, with events impacting specific resource availability in specific periods as shown in FIG. 32;

FIG. 37 shows a planning scenario with reduced resource levels in some of the nine functional groups, shown in FIG. 22, and creation of a new team “TeamAlpha”, with two resources shared between TeamAlpha and Product Development group, where Task #30 in the NPD Process Template shown in FIG. 2, is now assigned to this new team “TeamAlpha”;

FIG. 38 is a project dashboard showing projected completion dates and project slack for nine sample projects resulting from the application of the present invention to “reduced staff + deferred project starts + TeamAlpha (shared resources)” scenario, with events impacting specific resource availability in specific periods as shown in FIG. 32;

FIG. 39 shows a chart of tasks assigned to TeamAlpha and the resources in TeamAlpha, who are shared with Product Development, in a given time period, resulting from the application of the present invention to “reduced staff + deferred project starts + TeamAlpha (shared resources)” scenario, with events impacting specific resource availability in specific periods as shown in FIG. 32;

FIG. 40 shows a planning scenario with reduced resource levels in some of the nine functional groups, shown in FIG. 22, and creation of a new team “TeamAlpha”, where two Product Development resources have been moved from that group to TeamAlpha, and Task #30 in the NPD Process Template in FIG. 2 is now assigned to this new Team TeamAlpha;

FIG. 41 is a project dashboard showing projected completion dates and project slack for nine sample projects resulting from the application of the present invention to “reduced staff + deferred project starts + TeamAlpha” scenario, with events impacting specific resource availability in specific periods as shown in FIG. 32; and

FIG. 42 shows a chart of tasks assigned to TeamAlpha and marketing resource MK Resource 01, in a given time period, resulting from the application of the present invention to “reduced staff + deferred project starts + TeamAlpha” scenario, with events impacting specific resource availability in specific periods as shown in FIG. 32.

### DETAILED DESCRIPTION

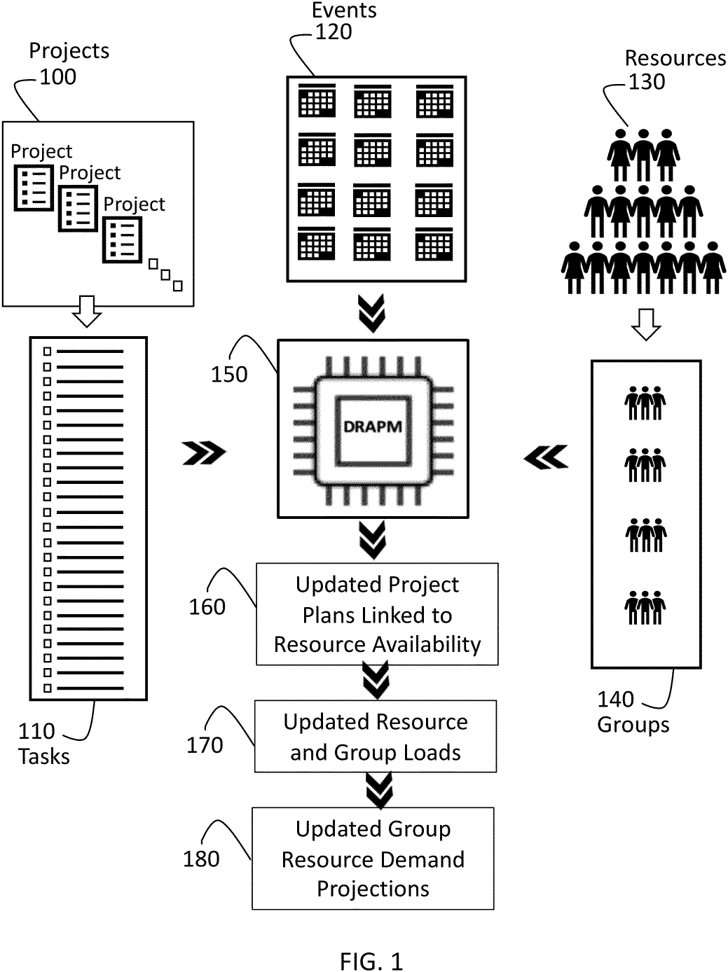

FIG. 1 provides a block diagram representation of a primary objective of the present invention. A collection of projects 100, each project having multiple tasks within the project, require resources to be assigned to each of the tasks at specific periods of time in the future when the tasks are expected to be performed. The timing of the tasks is a result of the dependencies of some project tasks on completion of other project tasks. A specific set of skills and knowledge is required to complete each project task. The collection of tasks from all projects results in a list of tasks that is prioritized and listed in some order 110. The resources available in the organization to perform work 130, are organized into required groups 140 with varied skill sets and experience to match the requirements of the project tasks. Some groups can have one or more common resources shared between them. The calendar of events 120 consist of company events, group events or personal events such as vacations, holidays, off site meetings, special assignments, work initiatives and many other such events that impact specific resource availability for specific periods at different points in time. Projects, Tasks, Resources, Groups and Events are dynamic in nature, which means additions/deletions/changes happen frequently.

The present invention, Dynamic Resource Allocation based Project Management system 150, has to take all of this information in real time and create resource allocations to each of the project tasks, across all projects, avoiding any conflicts with other tasks or events, and extending the time required to complete certain tasks to account for events that impact resource availability after task start dates. Real time project plans linked to availability of current resources 160, and corresponding view of resource and group loads 170, as well as projections of resource demands over time, for planning purposes, 180, are the outcome of the dynamic resource allocations. The outcome ensures that no resource is double booked on multiple project tasks at any point in time. The solution also ensures that the defined daily workhour capacity is not exceeded, and no work is planned or forecasted on defined weekends and holidays. Project plans based on dynamic resource allocations provide a realistic timeline of the capability of an organizational resource pool to complete the projects.

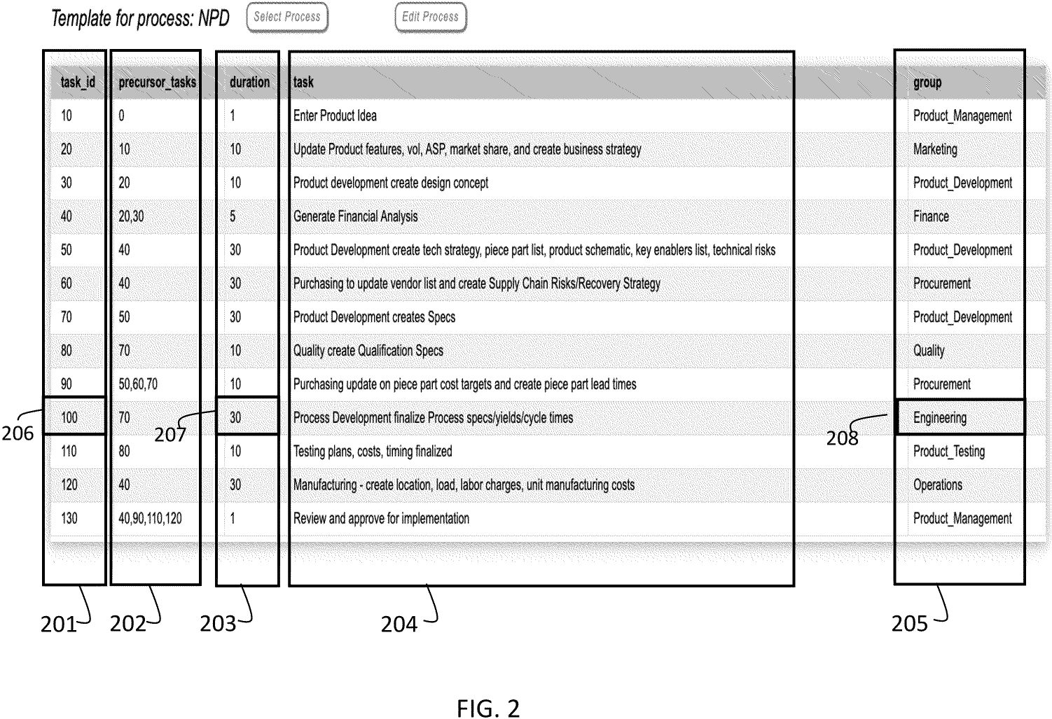

Often, project plans are built based on a process template which consists of a set of predetermined tasks that need to be completed to meet the desired project results. An example of a generic New Product Development process template, which will be used to illustrate the application of the present invention, is given in FIG. 2. The process template consists of a set of tasks, each task having an identification 201, information on dependencies on other project task completions 202, task duration in days 203, description of the task 204, and the group that is qualified (resources have required skill sets and knowledge) and assigned to perform the task 205. The invention is applicable for handling resource allocations to tasks in projects built on any process template, in any industry, or handling projects not based on a process template, or projects built on some process template and further modified, or different variations and combinations of projects. The invention provides a system and method to handle resource allocations to tasks across all such projects without resource conflicts and minimizing overall delays. The invention can be used to create initial project plans in planning stages, as well as to maintain and update project plans in real time, as projects are actively worked on. The invention can be used to help determine required resource levels in various groups. The invention can be used to plan different outcome scenarios with projects as described in the summary of invention. The invention can be used to automatically monitor and update resource allocations and project plans to account for delays from overdue project tasks. Resources are assigned across the entire set of project tasks every time in a coordinated manner; inputs can be adjusted to influence the outcomes on resource allocations and forecasted dates.

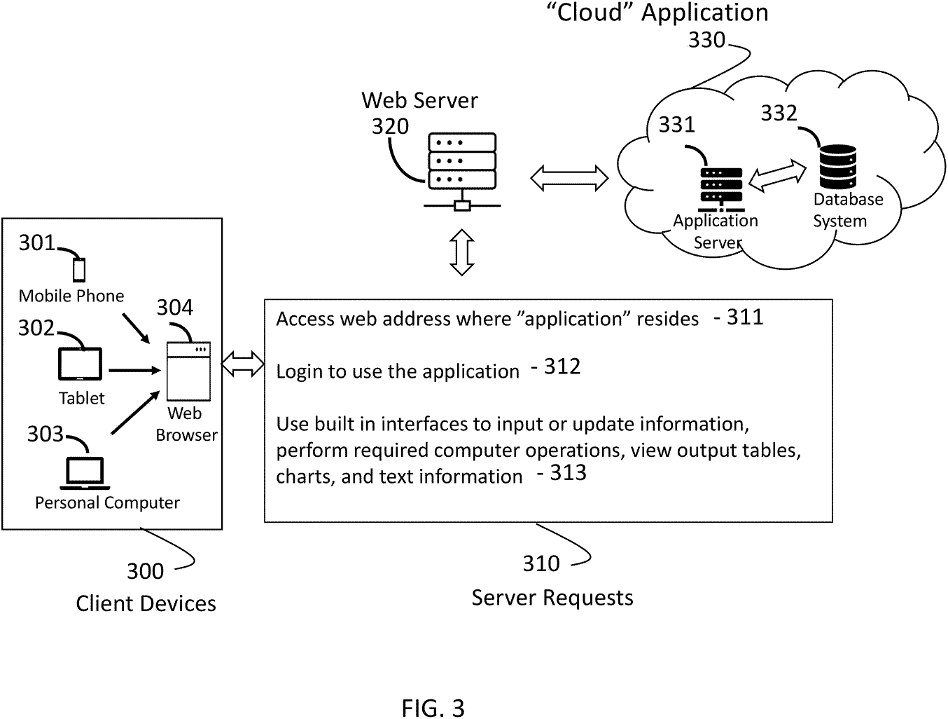

FIG. 3 provides a block diagram representation of the Dynamic Resource Allocation web-based system. A user uses one of the client devices 301 - 303 or similar device to launch a web browser 304 on the device, access the address on the internet web where the Dynamic Resource Allocation application (“application”) resides, step 311, logs in with a username and password to access the application, step 312, and uses the built in interfaces to perform specific operations, step 313. A web server 320 serves the server requests 310 made by the user through the web browser in steps 311 - 313. To serve the user, the web server 320, connects with the application in the “Cloud” 330, which means the application is hosted on a remote application server 331, and the database system 332 that the application uses to store and retrieve data is also hosted on a remote server. The location of the remote application server and the database can be defined as needed in the setup of the application configuration.

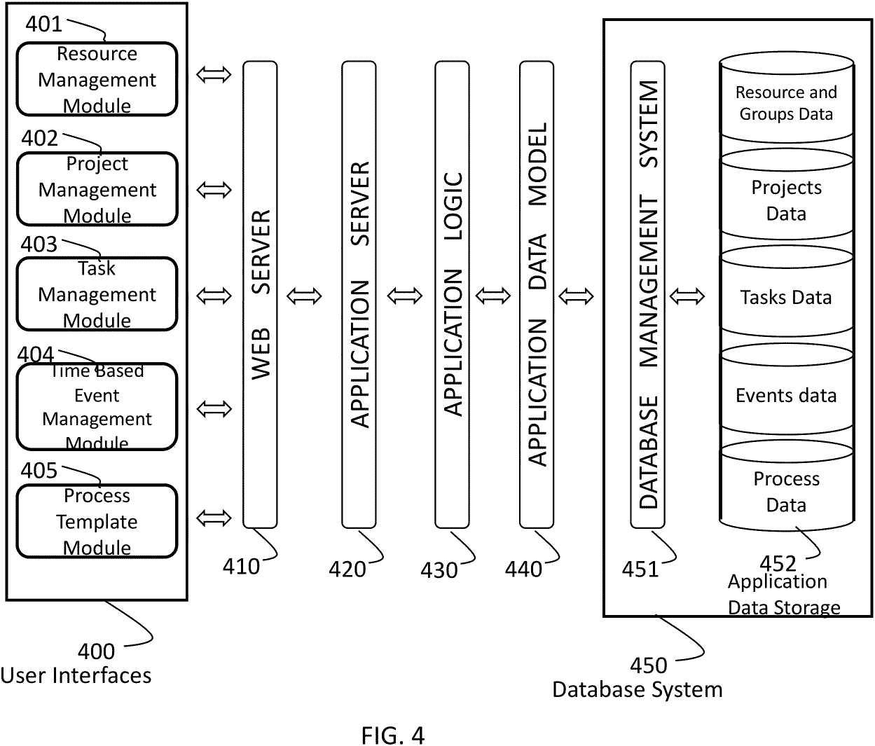

FIG. 4 provides the schematic representation of the application. The application consists of five management modules 401 - 405, that provide user interfaces 400 to the application. The interfaces are used to view, input, or update data on critical input parameters to the application, and to view outputs from the application. The critical input parameters to the application include: information on resources organized into groups with specific functional skill sets required to perform specific tasks, which is managed through the Resource Management module 401; number of projects, project plans and project priorities managed by Project Management module 402; number of project tasks, task status (“Open”, “Queued”, “Completed” or “Closed”), task duration, task effort, group ownership of tasks and task dependencies on other tasks, which is managed through the Task Management module 403; details on events impacting resource availability including the group or resource impacted, start date of the event impacting resource availability and the return date for the impacted resource(s), which is managed through the Time based event management module 404; and process templates used to build plans for new projects, each template consisting information on process tasks, and each process task on the template having information on process task identification, process task duration, process task group ownership, process task dependencies, and process task description, managed through the Process Template module 405.

Besides the User Interfaces, the application consists of Application Logic 430 in the form of computer executable code to perform desired functions and operations, and Application Data Model 440 which lists the data tables and the data fields within the tables, including the characteristics of the data stored in the fields and relationships between data fields on different tables. The Application Logic 430 uses the Application Data Model 440 to provide context while updating or retrieving Application Data that is stored in a computer readable database system 450, which comprises of a Database Management System 451 and a physical storage medium where Application Data is stored 452. The Application Data is created and/or updated as a result of user actions on inputting data or updating data via the User Interfaces 400 or as a result of operations performed by computer using the code in the Application Logic 430.

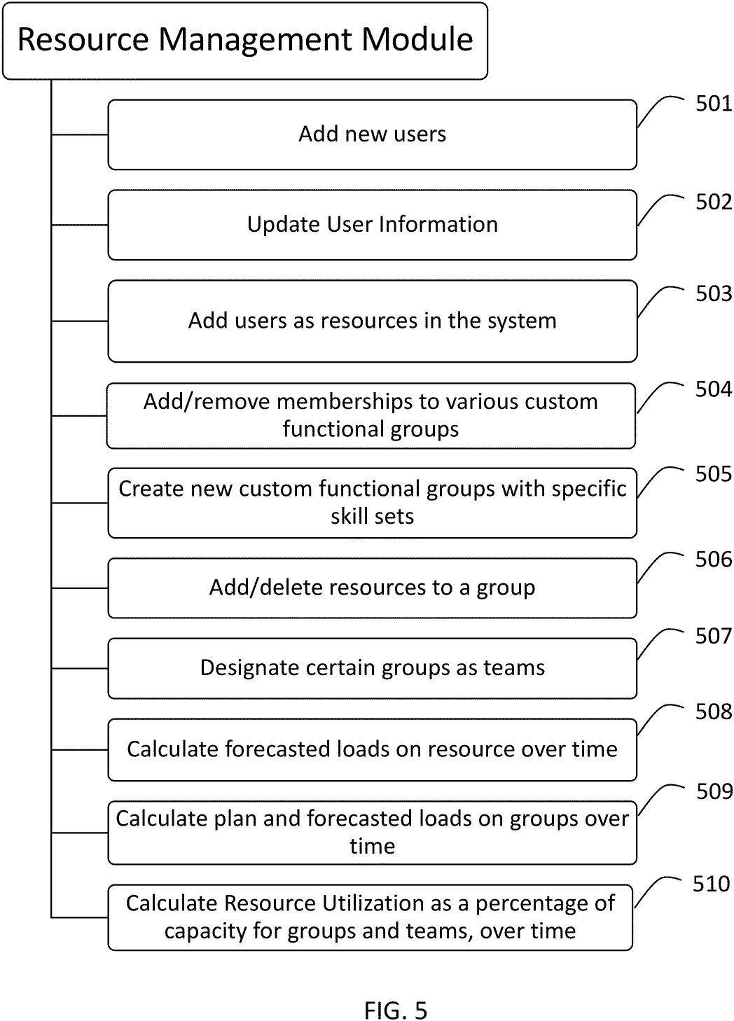

FIG. 5 shows the transactions managed with the Resource Management module part of the User Interfaces 400 in FIG. 4. A new user is registered in the Dynamic Resource Allocation Based Project Management System (“DRAPM System”) 501 with a user-id and password to login, along with information on First name, Last name, and email address. An existing user’s information can be updated 502, including changes to First name, Last name, email address, user “active” status, administrative groups that the user belongs to which determine DRAPM system access privileges, and date joined. A user can login and access information on the DRAPM system but is not considered a resource for the system to assign project tasks to, unless the user is identified or added as a “resource” 503, along with membership to specific functional groups that the user as a resource is qualified to belong. Functional memberships for a resource can be updated separately later 504. New custom functional groups with specific skill sets can be created as needed and members added to these new groups 505. For any functional group in the system existing members can be removed or new members added 506. Resources can be shared across different groups. Certain groups can be designated as a “Team”, 507, which has the implication that all the team members will be assigned to the same project task that requires the specific team to work on, during the time period required to complete the task.

On DRAPM system outputs, the forecasted loads on resources over time are calculated based on dynamic resource allocations, 508. Currently, in the preferred implementation of the present invention, in calculating the number of hours of activity for each task and determining the end date for a task given a start date, task duration is counted in business days (Monday through Friday), and for each business day, 6 hours of project work is the maximum allowed for any resource. However, which days of the week are workdays, and the maximum number of project workhours allowed each workday, can both be defined for the company, group, or individual resources in another implementation of the present invention. Plan and forecasted loads for each of the groups are calculated over time based on dynamic resource allocations 509. Resource Utilization as a percentage of group capacity can also be viewed for each month and for every group 510. The plan loads for each group provides a mechanism for resource planning for upcoming years project plans, in order to meet the project target dates while simultaneously ensuring resources are not double booked, resources are not booked beyond defined daily capacity of project workhours, and resources are not booked on defined weekends and holidays.

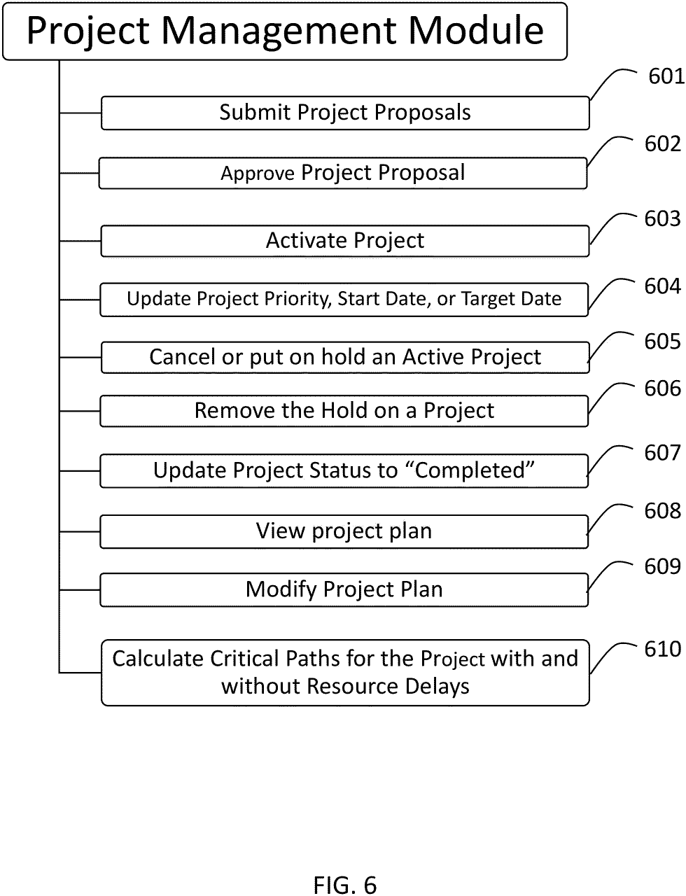

FIG. 6 shows the transactions managed with the Project Management module part of the User Interfaces 400 in FIG. 4. Project Proposals can be entered in the system 601. After review, a proposal can be “approved” to become a Project 602. When a project is approved, the DRAPM system will start assigning resources to the tasks in that project. When an approved project is activated 603 all project tasks that can be opened up for resources to work on, will be set to a task status of “Open”. A project that is approved in the system to commence at a future date cannot be activated till the planned start date for the project. Project priority, Project Start Date and Desired Target Date for Project Completion can be adjusted 604. A project can be cancelled or put on hold 605.

When a project is cancelled, records on all open and future or “queued” tasks in the project are deleted. Any records on tasks that were completed and/or closed are saved for future reference. When a project is put on hold, all resource allocations to the tasks on that project are removed, and all open tasks are converted to “queued” status for a future date when the project may be reactivated. No resource allocations are done to tasks in projects that are on hold. When the hold is removed on a project 606, the status is changed to “approved” first and plan dates for the project tasks are calculated from the day it was reactivated. The system will commence allocation of resources to the project tasks.

When the status on the project is set to “active”, all project tasks that can be opened up for resources to work on, will be set to a task status of “Open”. When all tasks in a project have been completed and closed, Project Status can be updated to “Completed” 607. Completed Projects are removed from Project Dashboards. No resource allocations are required or made to tasks in completed projects. Project plan which consists of the tasks and the plan and forecasted start and completion dates for each of the project tasks can be viewed for any project 608. Tasks can be added to a project, or an existing “queued” task can be deleted from a project 609. Also, the duration, task dependencies, and group ownership for any of the queued tasks in a project can be changed 609. Critical paths, which are the longest duration path, in terms of interconnected set of tasks within the project from start to finish, can be calculated for any project 610. Critical path length determines how long a project takes to finish. In addition to looking just at plan durations of tasks to calculate the critical path, the system can also calculate a real time view of the critical path including any delays caused from availability of resources to complete the tasks 610.

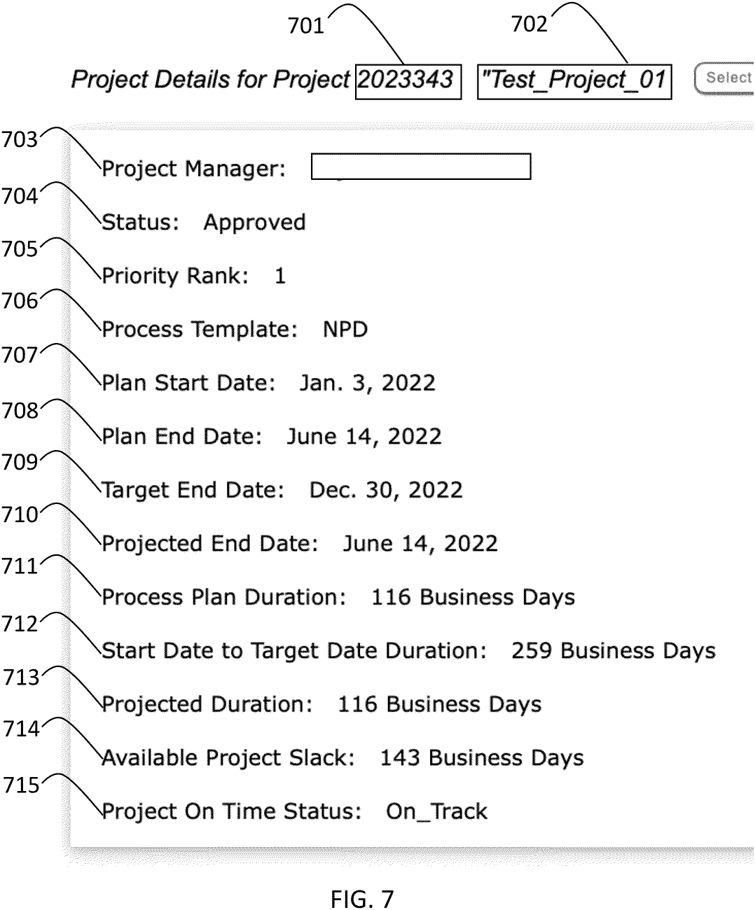

FIG. 7 shows all of the critical attributes of a Project record in the DRAPM system. Each project record has an unique id 701, a project title 702, a project manager 703 with the access privileges set up 502 to be able to update project 604, and make project plan modifications 609, project status 704 (“Approved”, “Active”, “Cancelled”, “On-Hold”, “Completed”), project priority 705 (a lower number indicates higher priority for allocation of resources), process template that the project plan is initially based on 706 (project can also be built on a “blank process template” to begin with), Plan Start Date 707, Plan End Date which is calculated based on the tasks and their durations 708, desired completion date (“Target End Date”) for the project 709, Projected End Date based on resource allocations 710, and On Time Status of the project 715, relative to Target End Date 709. Process plan duration 711 is calculated and is the difference in business days between the Plan Start Date 707 and Plan End Date 708. 712 is the difference in business days between Plan Start Date 707 and the Target End Date 709. Projected Duration 713 is the difference between the Plan Start Date 707 and the Projected End Date 710. Available Project Slack 714 is the difference in business days between the Target End Date 709 and Projected End Date 710.

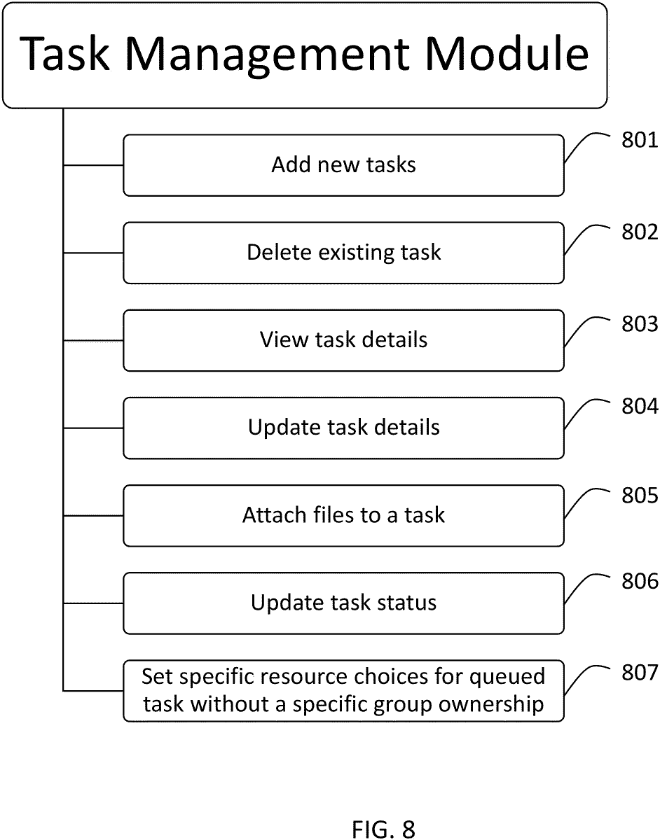

FIG. 8 shows the transactions managed with the Task Management module part of the User Interfaces 400 in FIG. 4. A new task can be added to an existing project 801 or a task in a project can be deleted 802. Details of any task record can be viewed 803. Task records can be updated 804 with changes to duration, comments added or edited, and group ownership changed. Files related to the task activity or output of the task can be attached or deleted 805. A project task goes through three status changes 806. It starts out as a “queued” task that will be executed at a future time period. The present invention dynamically assigns resources to all queued tasks to be performed in future. However, these resource allocations can continue to change dynamically for the queued tasks from the application of the present invention. When it is time for a task to start, it changes from “queued” status to “open” status. The task is identified as an open task for the particular resource who was assigned the queued task at the time the task status changed from “queued” to “open”. The resource assignment on the “open” task will not change after it is open. Group ownership on an open task cannot be changed.

When the resource completes the work, the task status can be updated to completed 806. This in turn will open other “queued” tasks that were dependent on the task getting completed. A project manager can review the completed task and close it 806, if all the required details and file attachments are present. Once, a task has been completed, its duration is determined by the actual open and actual completed dates and cannot be edited. Once a task is closed, no further changes can be made to the task record. The group ownership for the task determines the resource choices available to be assigned to a task. However, in some instances it may be desirable to define some specific resource choices or restrict choices to one resource, for a particular project task without defining a specific group ownership for the task 807.

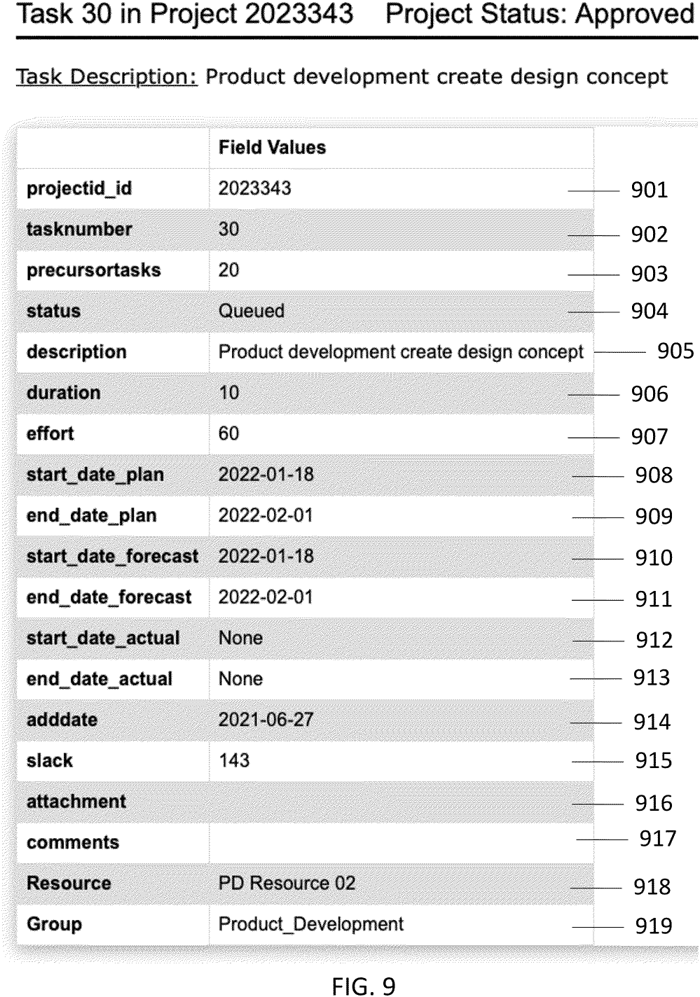

FIG. 9 shows all of the critical attributes of a Task record in the DRAPM system. As seen in the process template in FIG. 2, each project task has a unique identification 902 (“task_id” and “tasknumber” both refer to task identification), information on dependencies on other project task completions 903, task duration in days 906, description of the task 905, and the group that is identified to perform the task 919. In addition, a task record has the identification of the project that it belongs to 901, task status 904, effort in hours 907, plan start date 908 determined at the time the project plan was created prior to resource allocations, plan end date 909 calculated from the plan start date 908 and duration 906, forecasted start date based on dynamic resource allocations 910, a forecasted end date 911 based on forecasted start date 910, duration 906, (and any delays caused by events that impact resource availability after the forecasted start date), actual start date for the task 912, actual completion date for the task 913, date the task was added to the project plan 914, slack 915 which is the difference in business days between forecasted end date and the calculated latest date that the task can be completed while still meeting the overall project Target End Date 709, file attachments 916, comments 917, and the resource assigned to perform the task or the resource who performed the task 918. Task slacks are recalculated each time dynamic resource allocations are made, because forecasted end dates for tasks can change based on the latest resource allocations. File attachments made to tasks are stored in a specified folder on the application server where the application logic 430 and application data model 440 are stored. Alternatively, a different storage location can be specified for these files.

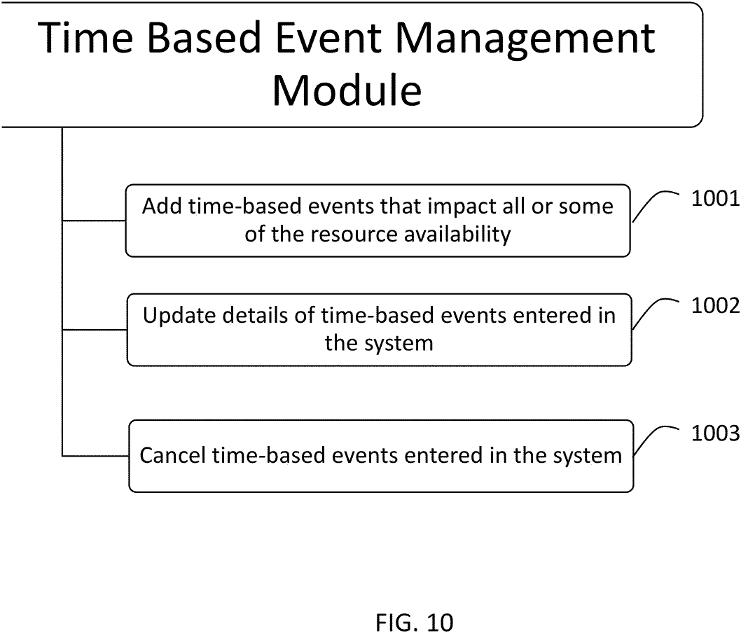

FIG. 10 shows the transactions managed with the Time Based Event Management module part of the User Interfaces 400 in FIG. 4. The events include, for example, company holidays, group off-site meetings, special group assignments, cross functional initiatives, team assignments, personal vacation, emergency assignments and many other such events that end up impacting one or more resources in the company at specific times and for various periods of time. The Time Based Event Management module provide simple interfaces to enter such events in the system 1001, update or change details of such events 1002, or cancel events entered in the system 1003. The critical details entered for each event recorded in 1001 include, start date for the event, return date from the event, whether it is an individual event impacting a single resource, or a group event impacting all resources in a group, or a company event impacting all resources, and the individual resource or group impacted if it is an individual or group event.

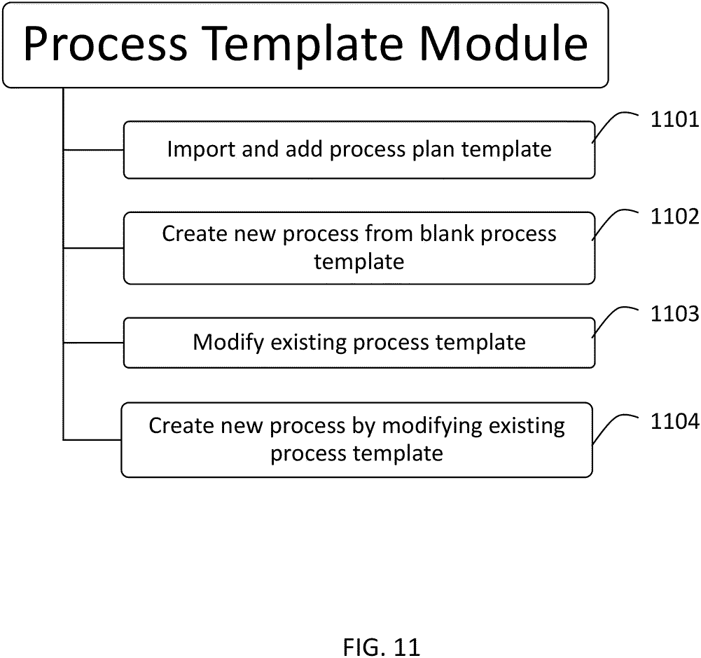

FIG. 11 shows the transactions managed with the Process Template module part of the User Interfaces 400 in FIG. 4. Process templates like the example seen in FIG. 2 are used to create project plans with prepopulated tasks for specific objectives. Each process template record on the database (referred to as Process Data in FIG. 4), consists of a name for the process template, and a location reference to an underlying spreadsheet that contains rows of tasks, and columns containing data for each task as shown in 201 - 205. Process template spreadsheet files can be directly imported into the DRAPM system and saved. The process spreadsheets are saved in a specified folder on the application server where the application logic 430 and application data model 440 reside. Alternatively, a different storage location can be specified for the process template spreadsheet files. Once the spreadsheet file is stored, a process template record can be created with a name for the process template and the link to the location of the spreadsheet file 1101. DRAPM system has a default process template with no tasks - a “Blank Process Template”. The Blank Process Template can be modified with addition of tasks, and a new process template record can be created with a new name 1102. Behind the scenes, a spreadsheet with new process tasks is saved in the specific folder location under the new name. An existing process template can be edited and saved 1103. An existing process template can be edited and saved under a new name as a new process template 1104. The original process template that was modified will remain under its old name.

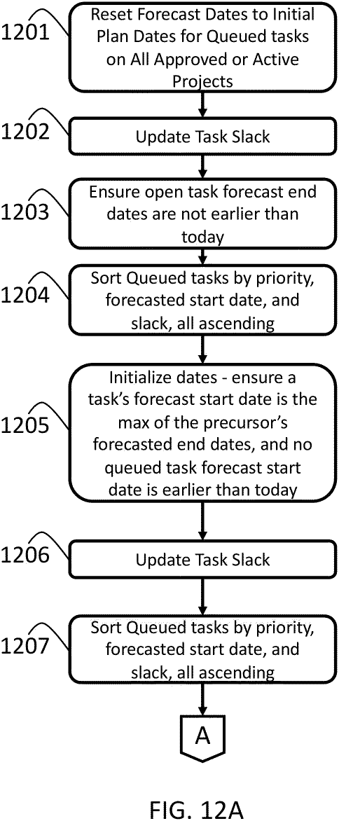

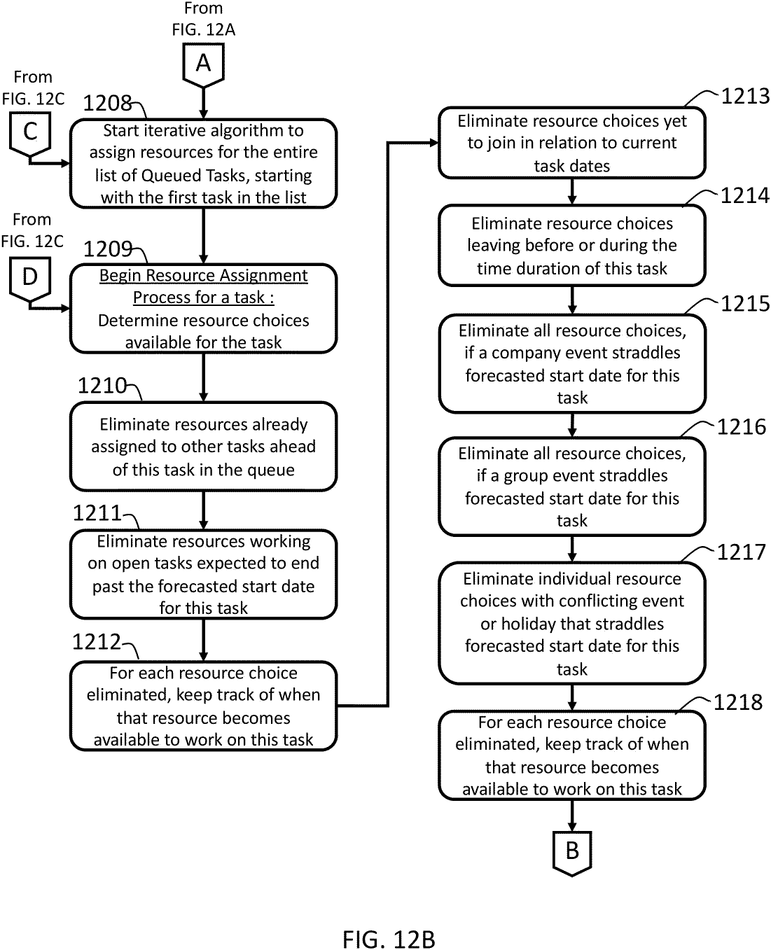

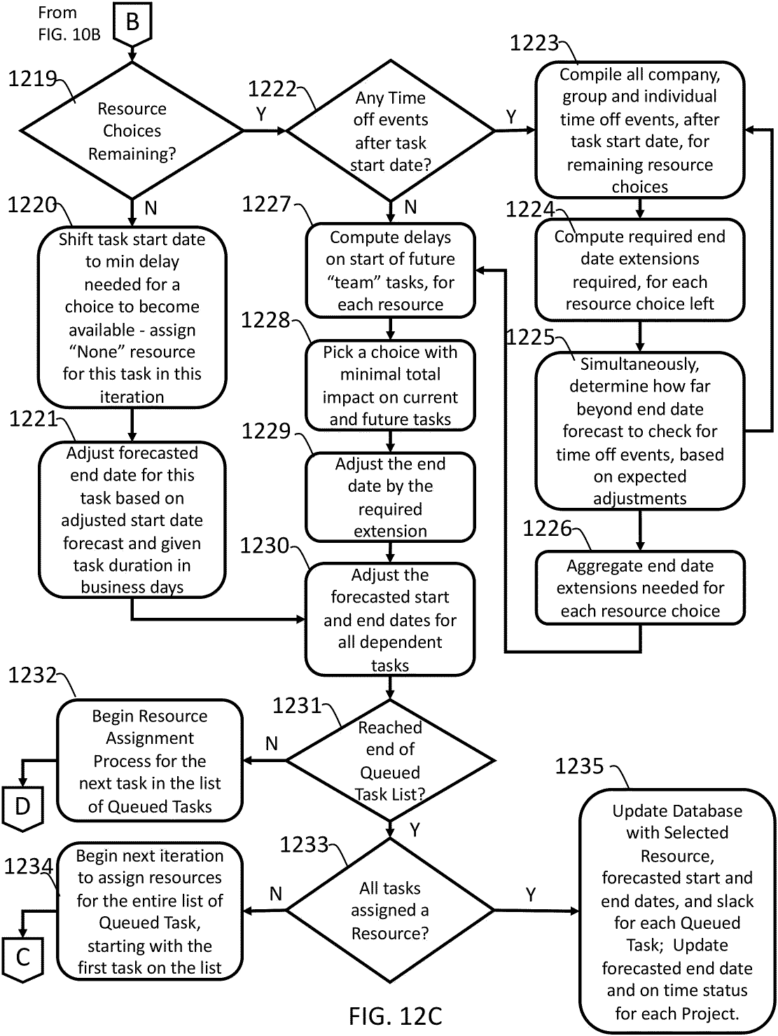

FIGS. 12A - 12C show the steps involved in a preferred implementation of Dynamic Resource Allocations to project tasks with a task status “Queued”. “Open” Project tasks have already been assigned to resources working on the tasks. “Completed” or “Closed” tasks do not require a resource. The steps depicted in FIGS. 12A - 12C can be further modified as required and/or new steps added based on new learnings and requirements.

Steps 1201 - 1207 shown in FIG. 12A, is a series of steps that sort and order the list of project tasks to be presented for resource selection. In Step 1201, the forecast dates for all queued tasks are set to initial plan dates. Since the forecast dates have been adjusted, slack is recalculated for all queued tasks 1202. Since some of the “queued” tasks may be dependent on completion of currently “open” tasks, and no queued task can start earlier than today, or, no open tasks can be completed earlier than today, in step 1203, all open task end dates are verified and adjusted if required to be no earlier than today. Queued tasks derive their priority from project priority number. In step 1204, queued tasks are sorted by priority number (a lower number indicates higher priority), forecasted start date, and slack, in that order, all ascending in their values. This sorting is important, as it can impact the convergence of the iterative resource selection process that follows. The sorted list of queued tasks is subject to a date initialization step 1205 which verifies and adjusts to ensure that indeed no task is starting earlier than today, and no task is starting before all its precursor tasks are scheduled to be completed. If forecasted start date is changed on any task, its forecasted end date is also changed correspondingly. Task slacks are again recalculated in step 1206 because forecasted end dates for some tasks might have changed in step 1205. Since slacks were recalculated in step 1206, the list of tasks is once again sorted by priority number, forecast start date, and slack in that order, all ascending 1207.

The sorted list of tasks is presented to the dynamic resource allocation process starting at step 1208 in FIG. 12B. The iterative resource selection process covers steps 1208 to 1234, shown in FIG. 12B and FIG. 12C. Once the resource allocation process is completed, and each queued task is assigned an appropriate resource, data record for each queued task on the database is updated, step 1235 in FIG. 12C, with the selected resource for the task 918, the forecasted start date for the task 910, forecasted end date 911, and slack 915. Also, based on resource allocations and forecasted end dates of project tasks, for each project, project data on the database is updated 1235, with the latest projected end date for the project 710, and the available project slack 714.

The dynamic resource allocation process is an iterative process 1208, starting with the first task on the list of queued tasks presented from step 1207. For every task in the list, steps 1209 in FIG. 12B through step 1232 in FIG. 12C is the resource selection process that is performed. Resource assignment for a task on the list begins with determination of the resource choices available for that task 1209. The resource choices are members of the functional group that owns the task 919. In some instances, it is possible that a custom set of resource choices are defined for a task without a defined functional group owning the task 807. From the resource choices available for the task as determined in step 1209, resources already assigned to an earlier task in the queue are eliminated 1210, and resources working on open tasks with forecasted end dates later than the forecasted start of the queued task for which resource is being selected are also eliminated 1211. For each resource thus eliminated, the earliest date that the resource becomes available is kept track of 1212. Next, from the resource choices remaining, resources yet to join the company in time to take up this task, if any, are eliminated from consideration 1213, and resources leaving the company before or during the time duration of this task, if any, are eliminated from consideration 1214. if there is a company event or a group event that straddles the forecasted start date of the queued task, all remaining resource choices are eliminated from the list 1215 - 1216. If no such events exist, resource choices that have a vacation or other event that straddles the forecasted start date of the queued task are eliminated 1217. For resources eliminated in steps 1215 - 1217, the earliest date that each of the eliminated resource becomes available is kept track of 1218.

If after step 1218 in FIG. 12B, no resource choices are left 1219 in FIG. 12C, a resource choice of “None” is assigned to the task and the forecasted start date for the task is shifted to the earliest date that one of the eliminated resources becomes available 1220 FIG. 12C. The forecasted end date for this queued task is then also shifted based on the adjusted start date forecast and the task duration in business days 1221.

If after step 1218 in FIG. 12B, resource choices remain to potentially start the task on the forecasted start date, the next check is to see if there are events impacting availability of one or more resource choices after the forecasted start date, but before the forecasted end date 1222. If there are no events impacting resource availability after the forecasted start date of the queued task, delays to the completion of the task as a result of assigning any of the available resource choices will be zero business days. However, if there are one or more events impacting the availability of one or more resources, there could be potential delays to the completion of the task, based on the resource selected for that task from the available resource choices. If in Step 1222 it is determined that there are one or more events impacting the availability of one or more resources, a list of all such events is compiled 1223. From this list of events, for each of the resource choice, potential delays, in days, to the completion of the task is computed 1224. The delays result in potential extensions to the end date forecast beyond the plan duration of the task. The minimum of such extensions is computed 1225, and steps 1223 - 1225 are repeated to check for impact of time off events over this extension period, computing the additional delays to the completion of the task for each of the resource choices, and checking again for the impact over the next minimum incremental extension, till there are no more events and additional forecasted end date extensions required. The set of delays or end date extensions resulting from the recursive steps 1223 - 1225 are aggregated for each resource choice 1226.

Next, if any of the resource choices is a member of one or more teams 507, potential delays to future team tasks as a result of the selection of the resource for the current queued task is computed 1227. For a resource choice with no future team tasks that may be impacted, future team task impact is zero business days. The resource with the least sum of, the delay to the current task for which resource selection is being performed and the delay to any future team task, is selected for assignment to the current task 1228. The current task’s end date forecast is adjusted by the required extension to the end date 1229, based on the resource selection in step 1228. The forecasted start and end dates of all future queued tasks that are dependent on the completion of the current task are adjusted 1230, based on the extensions made to the forecasted end date of the current task in step 1229, or the shifting of the forecasted start and end dates in steps 1220 - 1221. If the current task is not the last task on the list of queued tasks 1231, resource selection process is launched for the next task in the queue 1232. If the current task is the last task in the list and if any of the previous tasks have a selection of “None” for resource 1233, the next iteration of resource selection for the entire list of queued tasks starting with the first task in the list begins 1234. If all of the tasks have been assigned an appropriate resource, the database records are updated as explained before 1235.

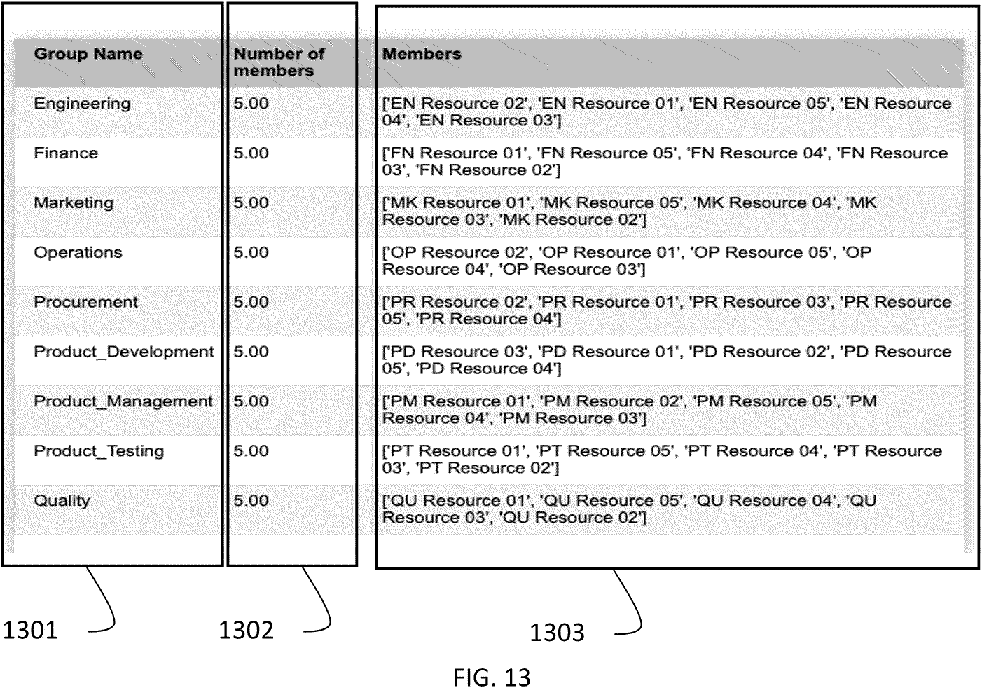

Figures FIGS. 12A - 12C provided a description of the structure of the present invention. Next, the application of the present invention will be illustrated through an example. The generic process template for New Product Development (“NPD”), FIG. 2, will be used to generate project plans, for the example illustration of the application of the present invention. FIG. 13 shows an organization with nine different functional groups 1301, each group containing five resources 1302, for a total of 45 resources, and their usernames are listed under “Members” of the group 1303. This example organization will be used for the illustration of the application of present invention.

In the preferred implementation of the present invention, only “weekdays” or “business days” (Mon - Fri) are included as working days in completing the tasks, and on a workday each resource is available for a maximum of 6 hours of effort towards project tasks. In this document, the terms “weekdays”, “businessdays”, “workdays” and “working days” all mean the same, and refer to the days of the week when project work is conducted. The definitions of which days of the week are workdays, and the number of hours available for project work from a resource on a workday, can be modified in different implementations of the present invention.

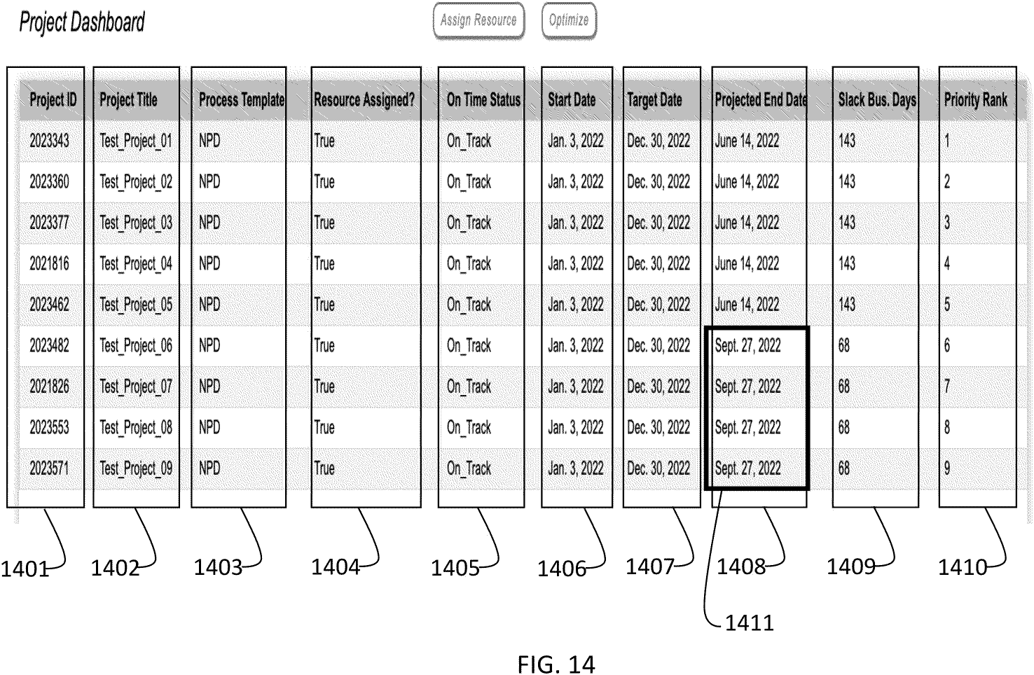

To keep the illustration straightforward, FIG. 14 shows a dashboard of nine projects 1402 created using the same NPD process template 1403. Each project has a unique project identification 1401. The column “Resource Assigned” 1404 indicates “True”, meaning, dynamic resource allocations have been made to all these project tasks. The resources that were assigned are from the example organization resources described in FIG. 13. In this example all projects have a start date of Jan. 3, 2022, 1406 with a target completion date of Dec. 30, 2022 1407. This base scenario will be referred to as “complete projects early”. Each project has a different priority number 1410, the lower this number, higher the priority, which means the project with the lowest priority number will get the resources first. While all projects have the same start date, four of the projects have a different projected end date 1411 as an outcome of dynamic resource allocations. Clearly the higher priority projects (lower priority number) are completed sooner, and the lower priority projects (higher priority number) are completed later. As a result, project slack 1409, calculated as the difference in business days between the projected end date 1408 and the desired completion date 1407, is higher for higher priority projects. All projects show an “On_Track” status 1405, relative to the Target Date listed 1407.

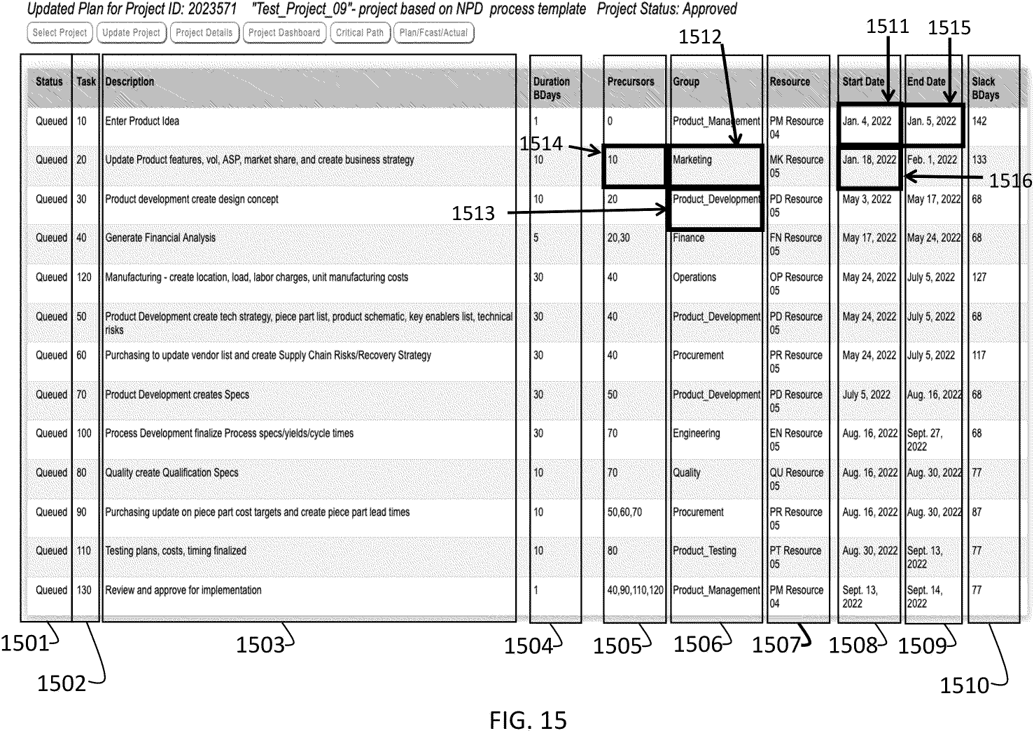

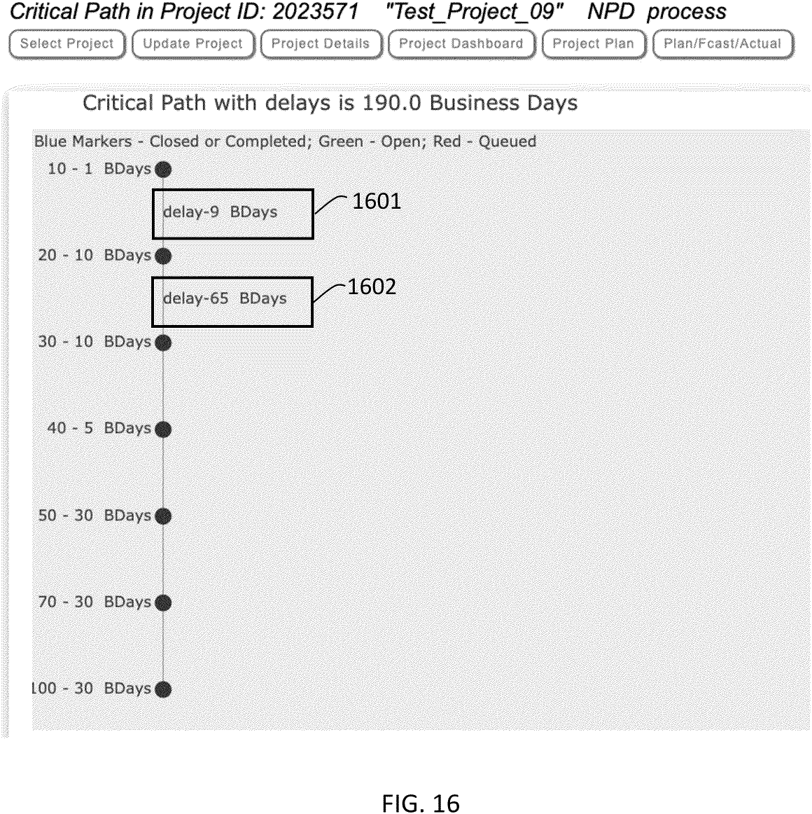

The outcome of dynamic resource allocations are project plans with forecasted start and end dates, which reflect the reality of delays caused by lack of resource availability. FIG. 15 shows a project plan for one of the projects with lower priority. The project plan includes a list of tasks belonging to the project. The project plan shows, for each project task, task status 1501, task identification 1502 (here referred to as “task”), task description 1503, task duration in days 1504, task dependencies on completion of other tasks in the project 1505, the group ownership for the task 1506, the resource assigned the task 1507 from dynamic resource allocations process, forecasted start date for the task 1508, forecasted end date for the task 1509, and the available slack in the task 1510. The available slack in the task is the difference between the forecasted end date for the task from dynamic resource allocations 1509 and the calculated latest end date possible for the task. The latest end date for each task is derived from the project plan, working backwards from the project completion target date 1407. The project plan start is Jan. 3, 2022 1406. However, the first task on this project starts on Jan. 4, 2022, 1511 indicating a one-day delay to start the project. FIG. 16 shows the critical path, the longest duration path within the project from start to finish, as a connected line of dots with task numbers and their duration in days listed. In addition to the one-day late start explained above, FIG. 16 shows nine business days delay in starting task 20 1601, and 65 business days delay in starting task 30 1602. FIG. 16 will not show any delays to project starts; it only plots the longest path within the project.

Looking back at the corresponding project plan in FIG. 15, task 20 is owned by the group “Marketing” 1512 and task 30 is owned by the group “Product Development” 1513. The precursor to task 20 is task 10 1514, which is forecasted to end on Jan. 5, 2022, 1515 but task 20 does not start till Jan. 18, 2022, 1516 because the earliest a Marketing resource is available to start the task is Jan. 18, 2022, a delay of 9 business days, from Jan. 5, 2022, to Jan. 18, 2022. Similarly, task 30 in the project is delayed by 65 business days, waiting for a Product Development resource. The project plans and critical paths are identical for the four projects Test_Project_06 through Test_Project_09 that are all getting completed on Sep. 27, 2022. In total, there is a delay of about 75 business days (1 day delay on the first task + 9 days delay on task 20 + 65 days delay on task 30) accumulating in the critical path of the project plans in each of these four projects from start to finish. Therefore, the projected end dates on these four projects are pushed from June 14 to Sep. 27, 2022 1411.

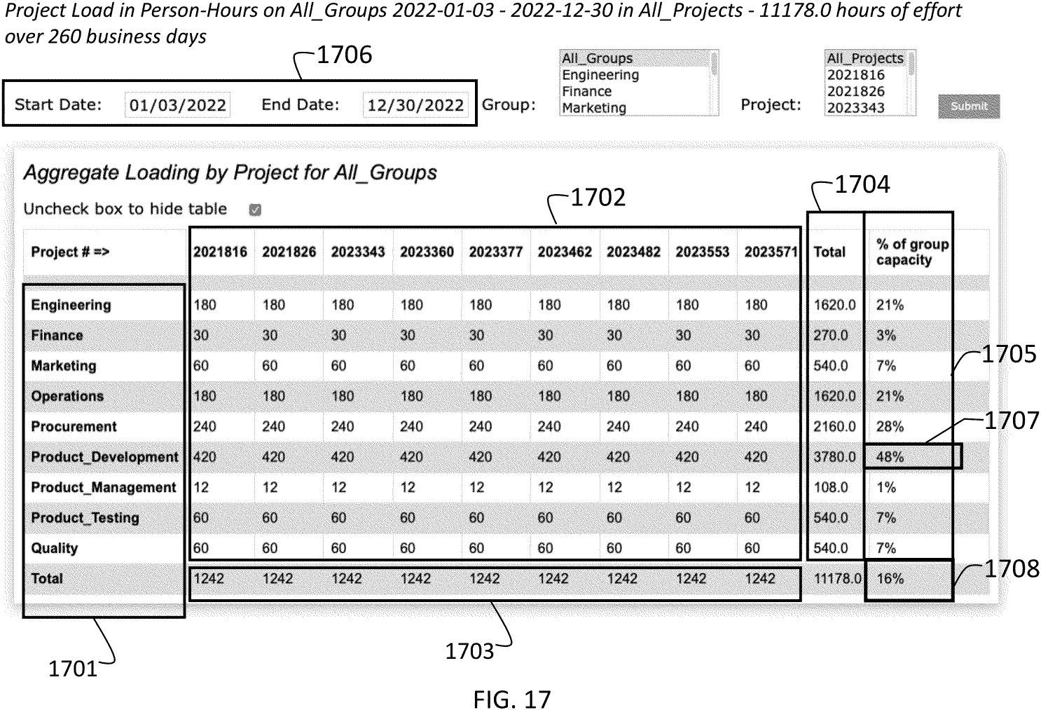

FIG. 17 shows the resource utilization as a percentage of capacity 1705 for all nine groups 1701, over a selected time period 1706. Capacity is defined as the total number of workhours available within the group in the selected time period, and is the product of, the number of workhours each day, the number of business days in the selected time period, and the number of members in the group. Forecasted workload is calculated for each of the functional groups, based on dynamic resource allocations, in workhours, assuming six hours of work per workday as explained before. The workhours for a task is the duration in days multiplied by six hours. The hours from all the tasks in a project, belonging to each of the groups, is aggregated and presented 1702 for each group - project combination. The table in FIG. 17 also shows the total workhours across all groups for a given project 1703, and the total workhours across all projects for a given group 1704. The total workhours across all projects for a given group is divided by the capacity for the group in the same time period, to arrive at the resource utilization expressed as a percentage 1705.

Many of the groups have low resource utilization percentages, below 25% 1705. The overall resource utilization across all group resources is 16% 1708. Product Development has the maximum resource utilization in this time period of 48% of the group capacity 1707. While Product Development is only utilized to 48% of its capacity, projects are still delayed 1411 due to lack of resource availability to start tasks 1602 at specific periods of time. In a real-world application, involving projects of various sizes and shapes, special work initiatives, and company, group, and personal events, availability is impacted at different points in time for different resources, in complex ways. The implementation of the present invention will help account for all such conflicts while assigning resources and generating project plans integrally linked to resource availability.

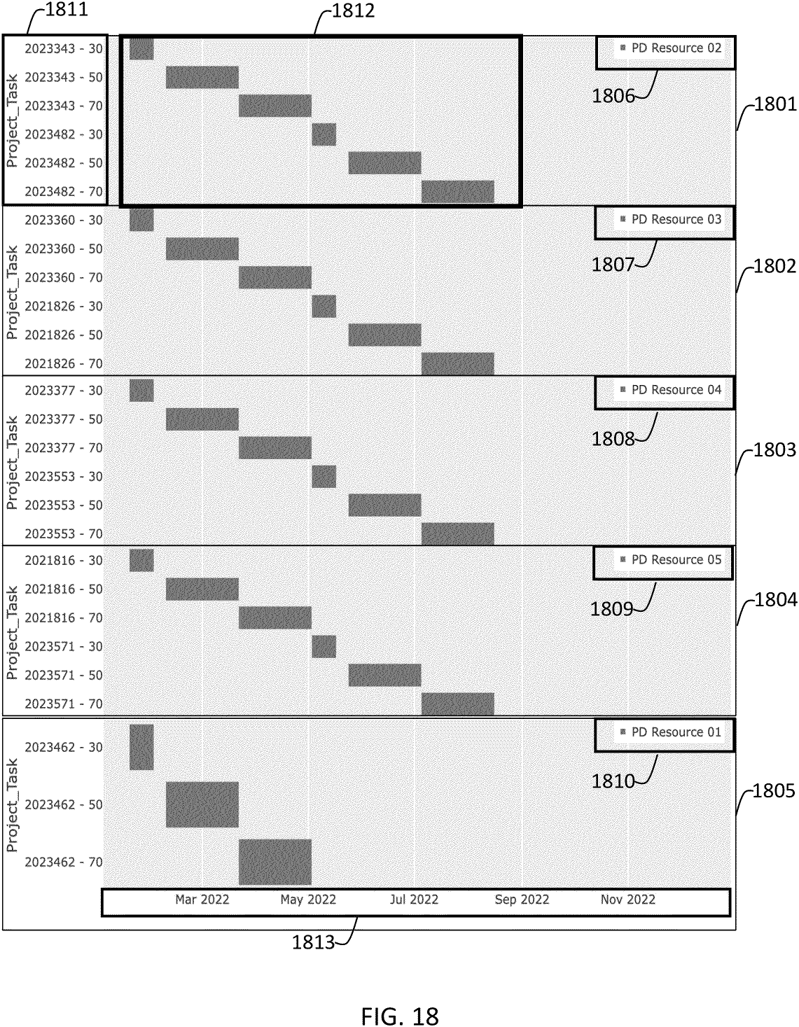

FIG. 18 shows five Gantt charts 1801 - 1805 of tasks assigned for each of the resources 1806 - 1810 in the Product Development group, over the selected time period 1706. In each of the Gantt charts 1801 - 1805, the y axis 1811 identifies the tasks in the format “project identification number - task identification number”. The x axis 1813 identifies the time in months in the selected time period and is the same for all five Gantt charts 1801 - 1805. The horizontal bars on each of the charts represent the time duration for the tasks. For example, in the first Gantt chart 1801, the horizontal bars 1812 represent the time duration of the tasks 1811 assigned to PD Resource 02 1806. The horizontal bars contained within each of the five charts do not overlap. In other words, at no time is any Product Development resource double booked on project tasks. This is a fundamental aspect and benefit of the application of the present invention.

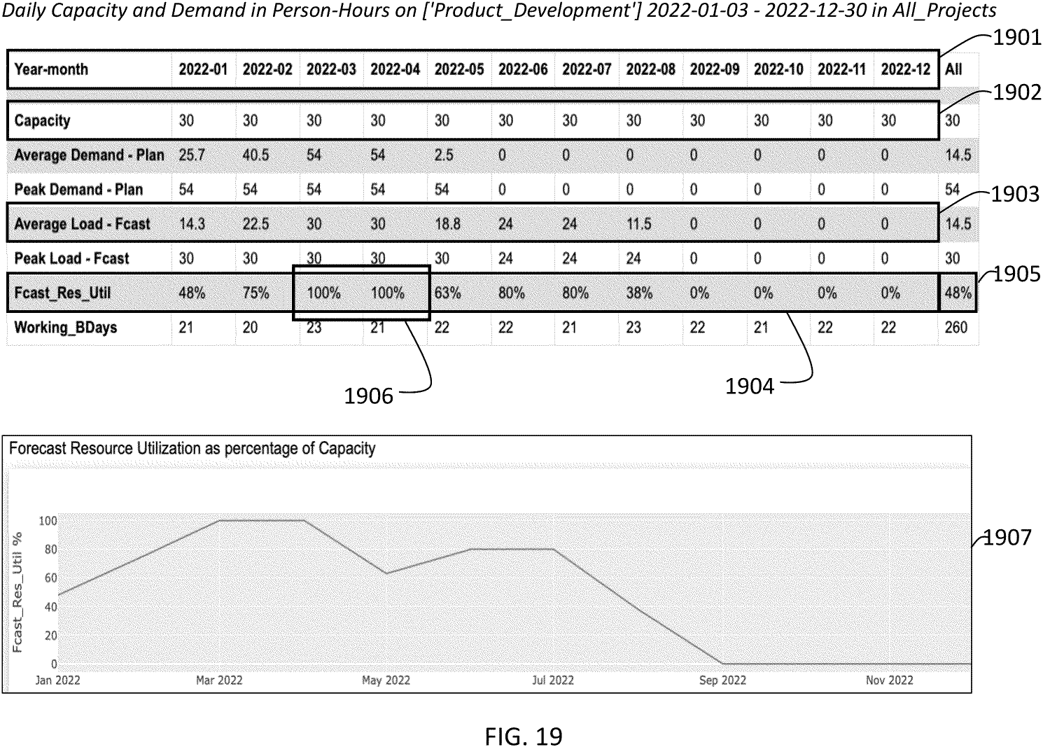

FIG. 19, shows the resource utilization percentages 1904 by month 1901 for Product Development, in the selected time period 1706. The resource utilization percentage is obtained by dividing the average daily forecasted load for the month in workhours 1903, based on dynamic resource allocations, by the daily capacity in workhours 1902. The overall resource utilization for the time period is 48% 1905, as seen before. Clearly, in some months, 100% of the Product Development capacity is utilized towards Project tasks 1906, which may not be ideal given other standard work that needs to get done. The chart 1907 plots the Forecasted Resource Utilization percentages 1904 on the y-axis and the months 1901 on the x-axis.

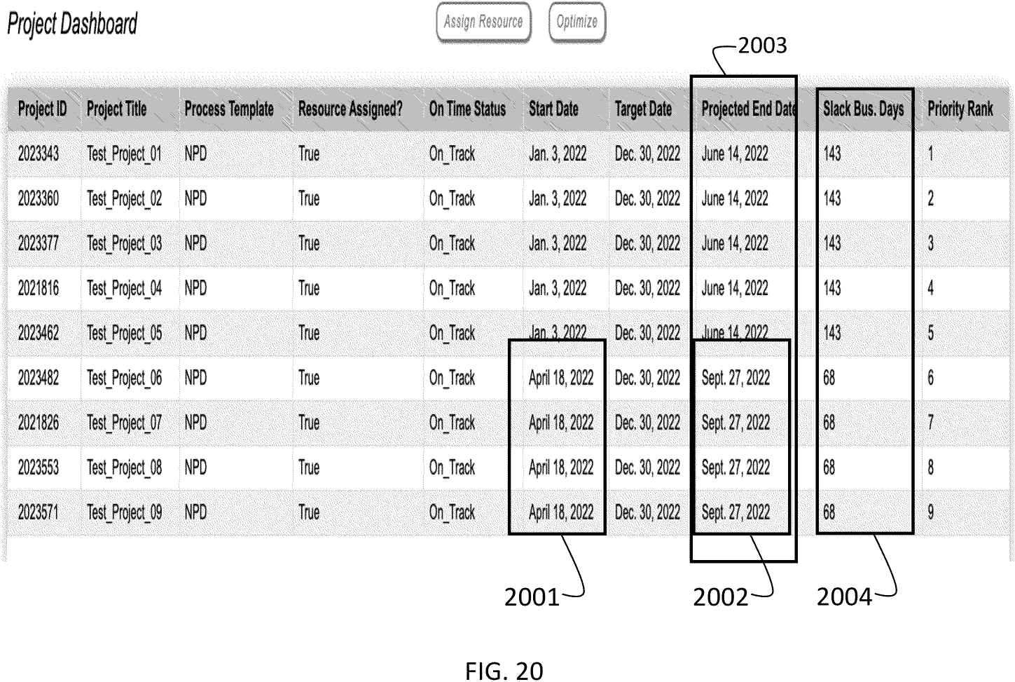

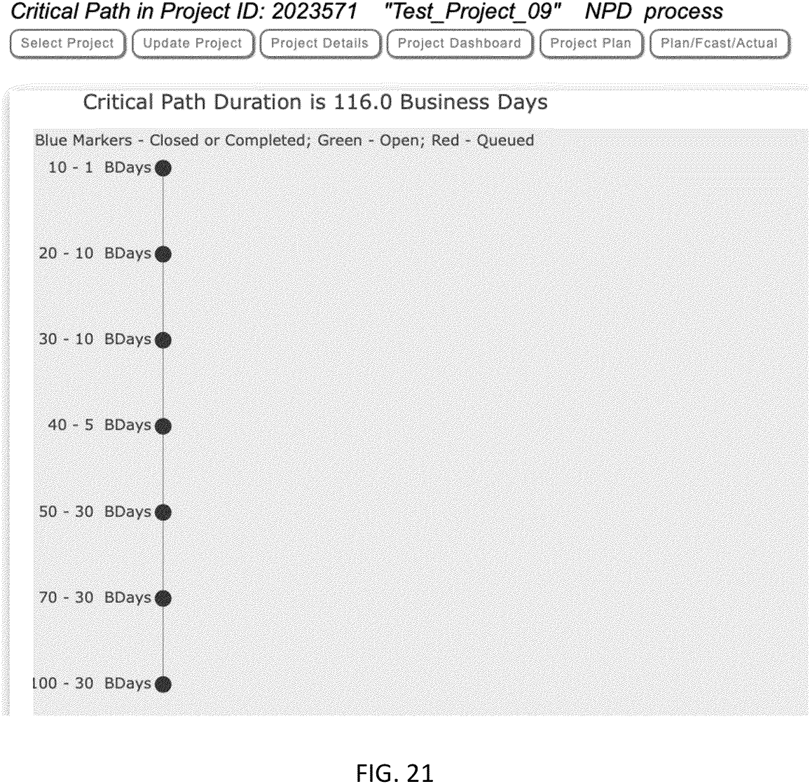

Since the four projects, Test_Project_06 through Test_Project_09, were delayed by 75 business days 1411, their start dates were shifted by 75 business days to Apr. 18, 2022, and resources were assigned. This scenario will be referred to as “complete projects early with deferred project starts”. The project dashboard FIG. 20, shows the same projected end date for these projects 2002, as in “complete projects early” scenario 1411, even though they were started later 2001. In resource and project planning, often, it is advantageous to stagger the projects, if it does not impact the end dates, as it reduces the feeling of busy activity without any benefits. The critical path shown in FIG. 21 now shows no delays (compare with FIG. 16).

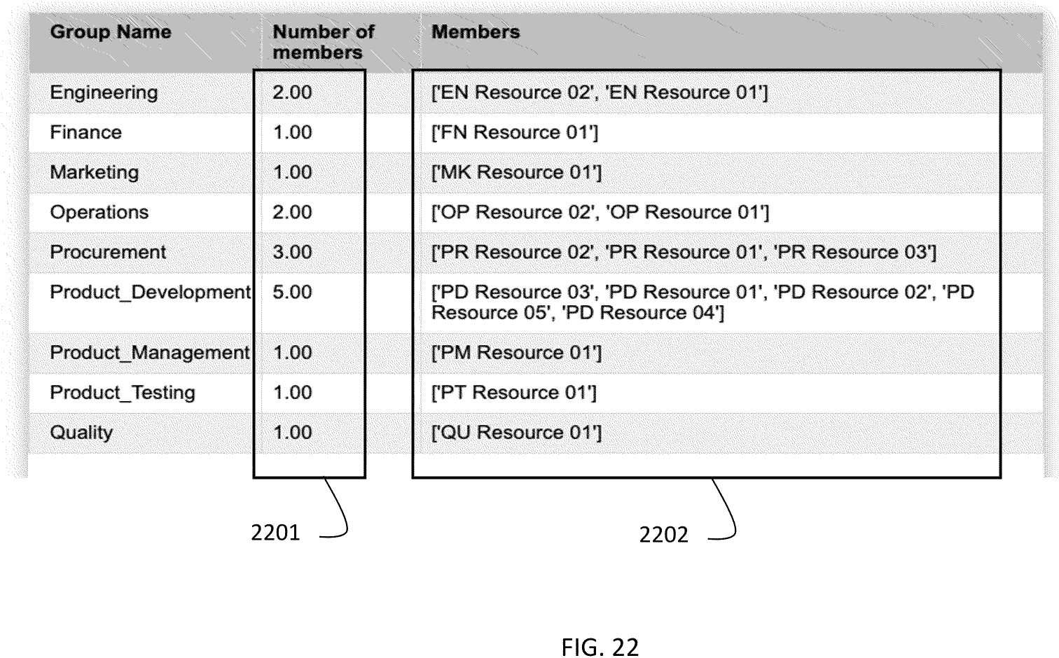

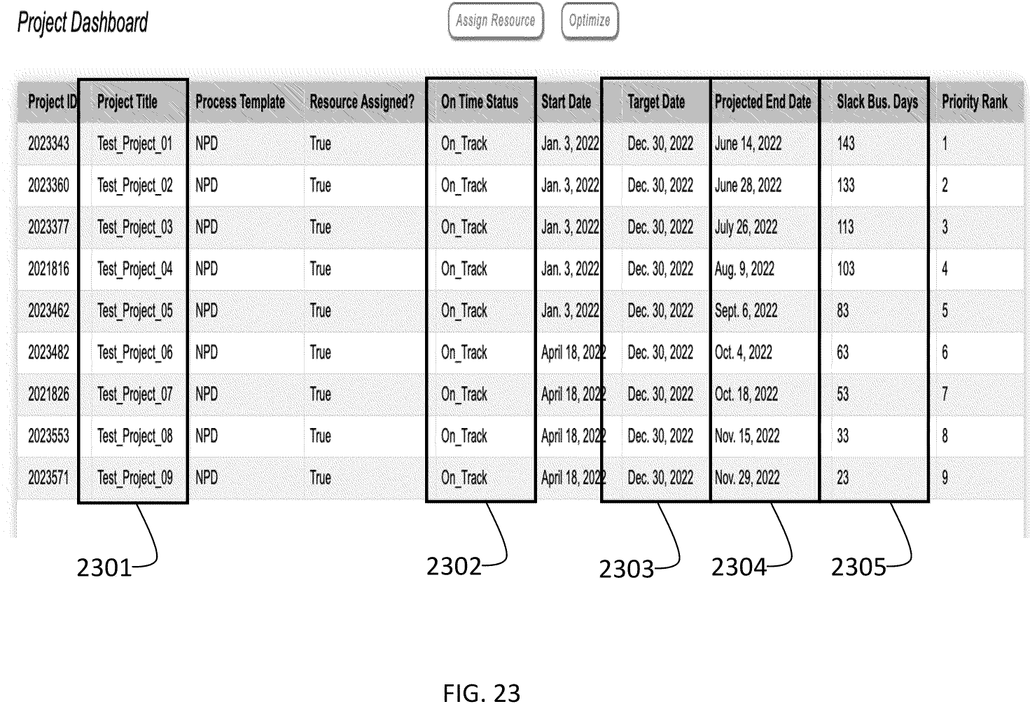

Since, the resource utilization percentages for many of the groups are below 25% 1705, resources can be moved out of these groups. FIG. 22 depicts a “reduced staff” plan, compared to FIG. 13, with the number of resources reduced in each of the groups 2201, except Product Development, resulting in a reduction in total number of resources from 45 to 17. FIG. 23 shows the project dashboard based on dynamic resource allocations to the project tasks, with the reduced resource levels 2201 shown in FIG. 22 and the deferred project starts 2001 shown in FIG. 20. This combination will be referred to as “reduced staff + deferred project starts” scenario. The projected end dates 2304 for most projects 2301 are delayed when compared to projected end dates in “complete projects early with deferred project starts” scenario 2003. Project status is still “On-Track” 2302 with respect to the desired target date 2303, which is Dec. 30, 2022, for all projects. However, project slacks 2305 vary and are much reduced compared to the “complete projects early with deferred project starts” scenario, 2004 in FIG. 20. If all that is required is that all nine projects are completed within the desired target date, then the objective is met with a much lower level of resources. Such exercises with the present invention provide a way for resource planning to take place in an informed manner. Besides resource levels, project start dates, project priorities, task durations, task ownership, number of tasks in a project, project target completion dates, number of projects, process methodologies, can all be varied as input parameters to the dynamic resource allocation algorithm to develop resource allocations for various scenarios meeting the business needs.

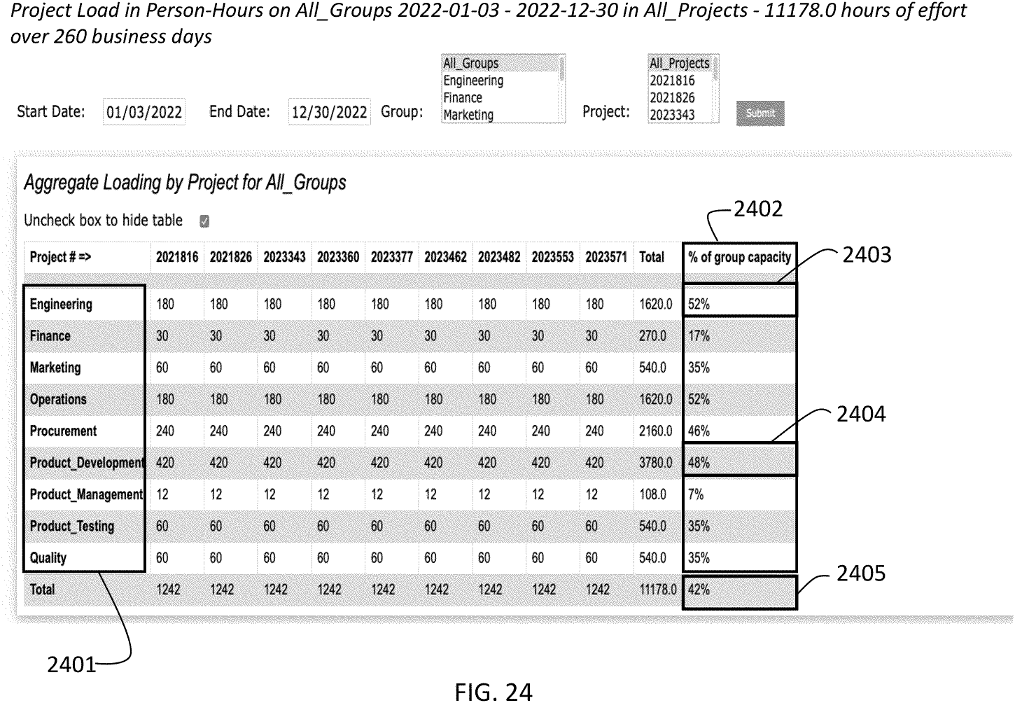

FIG. 24 shows the resource utilization percentages 2402 for the nine functional groups 2401 in the “reduced staff + deferred project starts” scenario. With the reduced staff, the resource utilization percentage jumps for most of the groups 2402. The Product Development resource utilization percentage remains at 48% 2404, since Product Development staff levels were not reduced, and the project loads are the same in the selected time period. Overall resource utilization percentage jumps to 42% for all resources 2405, compared to the “complete projects early” scenario, where overall resource utilization was lower at 16% 1708.

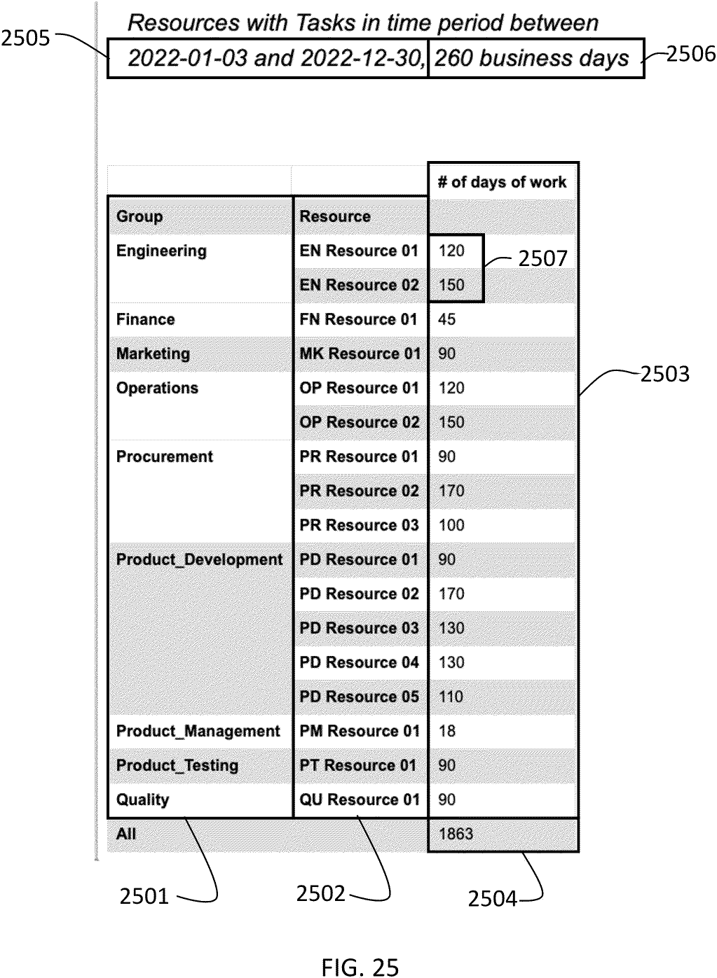

FIG. 25 shows the resource utilization in a different way, by listing all of the resources with assigned tasks 2502 within each of the groups 2501, in the selected time period 2505 (same as 1706), and the number of days of project work involved for each of the resources in this time period 2503. There are 260 business days in the selected work period 2506. All 17 resources 2202 listed in FIG. 22, have assigned tasks, amounting to a total workload of 1863 days of project work 2504 in the selected time period. The capacity in workdays is the number of resources, which is 17, multiplied by business days in the year, 260, for a total of 4,420 workdays of capacity. 1863 is 42% of 4,420, that is the resources are loaded to 42% of capacity with project tasks, which was also seen in FIG. 24 2405.

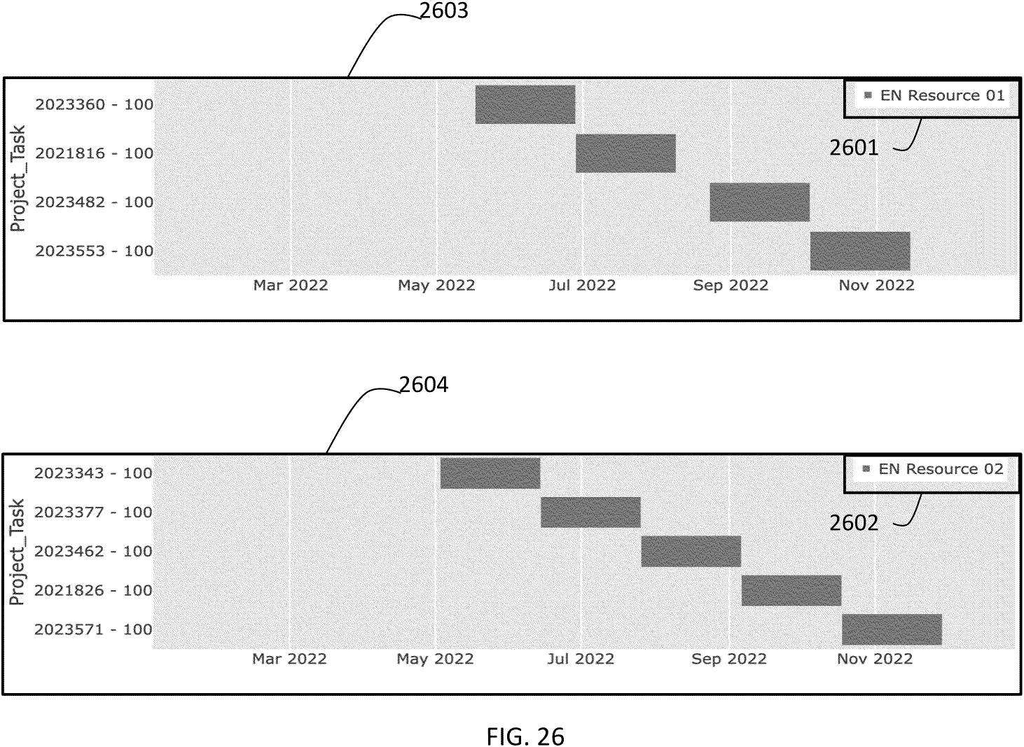

In FIG. 24, the Engineering group has a resource utilization percentage of 52% 2403, and in FIG. 25, the two engineering resources have a combined workload of 270 days of project work 2507. FIG. 26 provides the forecasted task activity, from dynamic resource allocations, for the two engineering resources 2601-2602, in the form of Gantt charts 2603-2604 of assigned project tasks over the selected time period. Once again it is clear that there is no overlap between tasks, in each of the two Gantt charts, indicating that the dynamic resource allocations ensure that no resource is double booked.

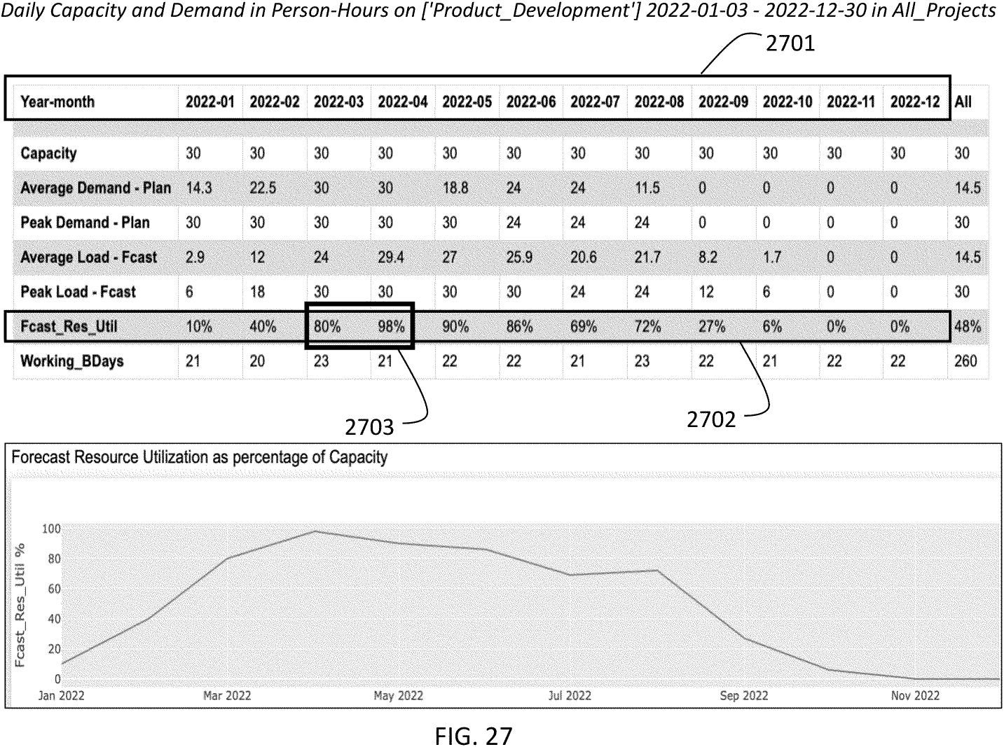

To complete the picture for the “reduced staff + deferred project starts” scenario, FIG. 27 shows the forecasted resource utilization percentage 2702 by month 2701 for Product Development. Even though Product Development staff level was not reduced, as a result of reduced staff levels in most groups, work is extended over time as expected, and this impacts the project workload distribution over time, even on Product Development group. It highlights the interactions resulting from dependencies of tasks on other tasks, and dependencies of tasks on resources from specific groups. The resource utilization percentages 2702 for Product Development in the “reduced staff + deferred project starts” scenario is somewhat more spread out in the year, when compared to the resource utilization percentages 1904 for the “complete projects early” scenario, shown in FIG. 19. The two peak months of 100% resource utilization 1906 seen in FIG. 19 for the “complete projects early” scenario, is absent and those percentages are somewhat less in those months 2703 in the “reduced staff + deferred project starts” scenario.

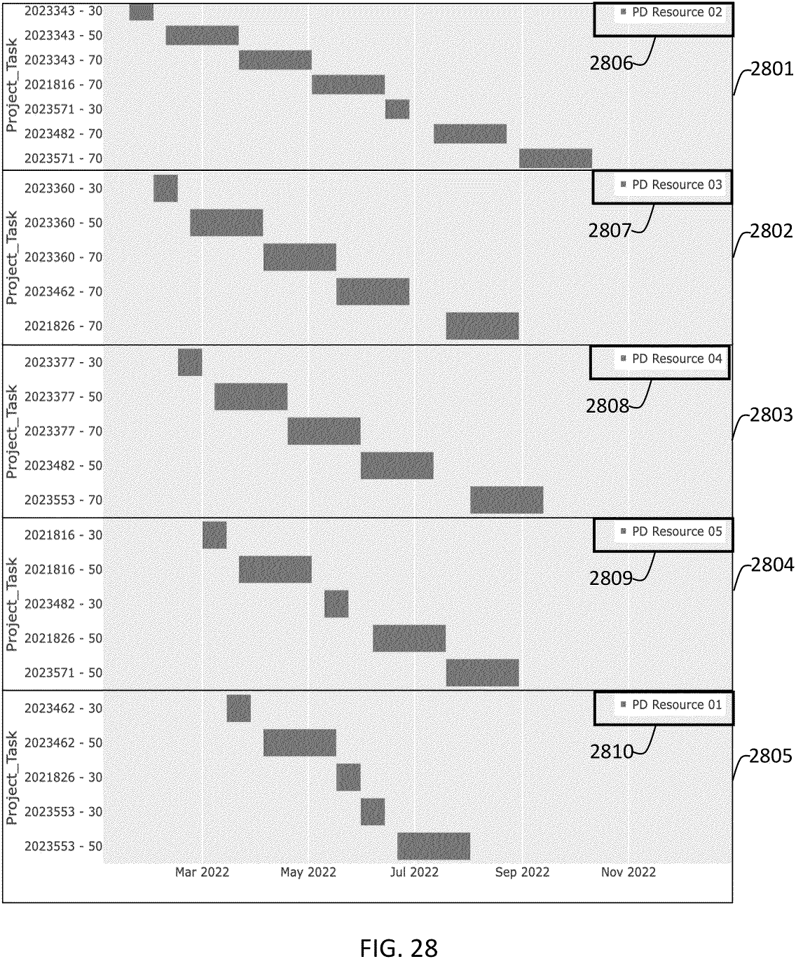

FIG. 28 is an identical chart to FIG. 18, and shows the distribution of tasks, for all resources in Product Development, for the “reduced staff + deferred project starts” scenario. The timing and distribution of tasks among the resources has changed in this scenario, compared to the distribution of tasks for “complete projects early” scenario, shown in FIG. 18. This can be seen by comparing the number of horizontal bars and the position of the bars on the horizontal axis, in each of the Gantt chart in FIG. 28 with the corresponding Gantt chart of assigned tasks for the same Product Development resource in FIG. 18. For example, compare Gantt chart 2801 with Gantt chart 1801, Gantt chart 2802 with Gantt chart 1802, and so on. There is once again no overlap of tasks for any resource in the Gantt charts in FIG. 28.

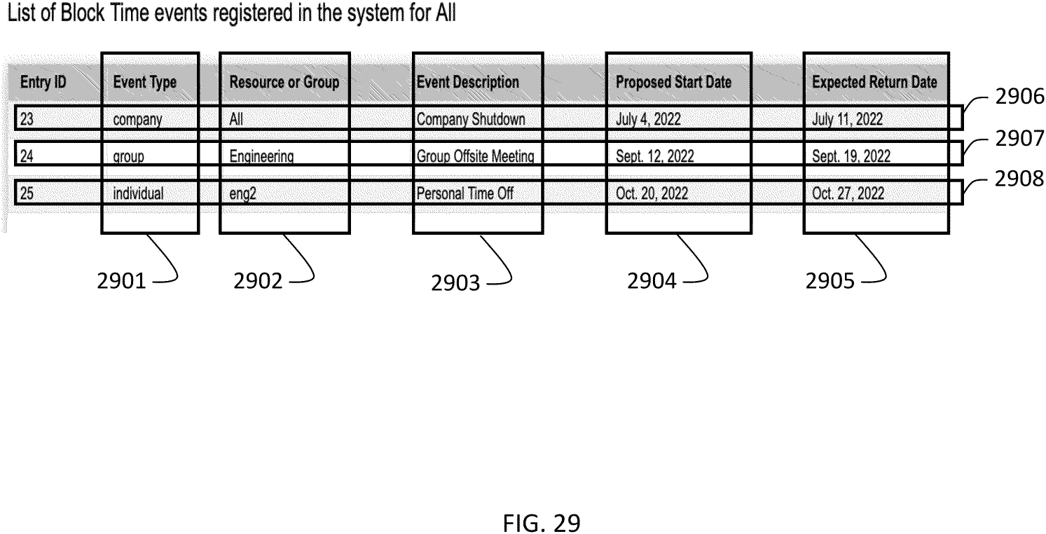

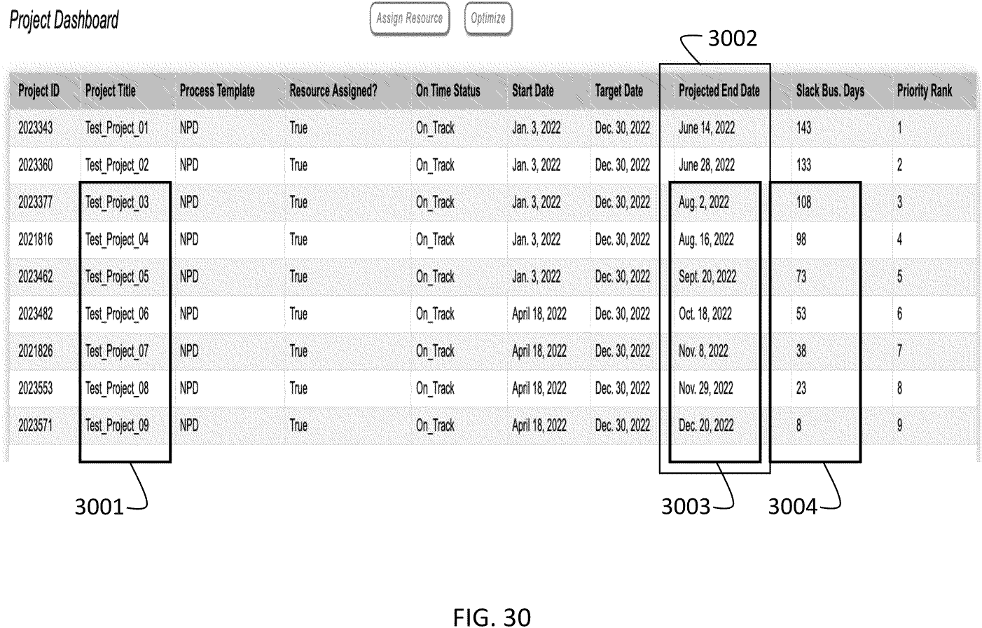

Next, consider the effects of events that impact resource availability for specific periods of time on dynamic resource allocations and project plans. FIG. 29 shows some events recorded in the system. Each event record includes data on event type 2901, which indicates whether it is a company event, group event or an individual event, resource or group impacted 2902, description 2903, the start date for the event 2904, and the return-to-work date after the event 2905. For illustration, we include a company event 2906, a group event 2907, and an individual event 2908. Dynamic resource allocations were run after the events were entered. The impact of events on resource availability based project plans are seen on the project dashboard in FIG. 30, for the “reduced staff + deferred project starts” scenario. FIG. 30 shows that the projected end dates 3003 on Test_Project_03 through Test_Project_09 3001 are all delayed because of these events, compared to the projected end dates without these events 2304. Their project slacks 3004 are less as a result, compared to project slacks without these events 2305; but the projects are all still completed in the year 2022 3003.

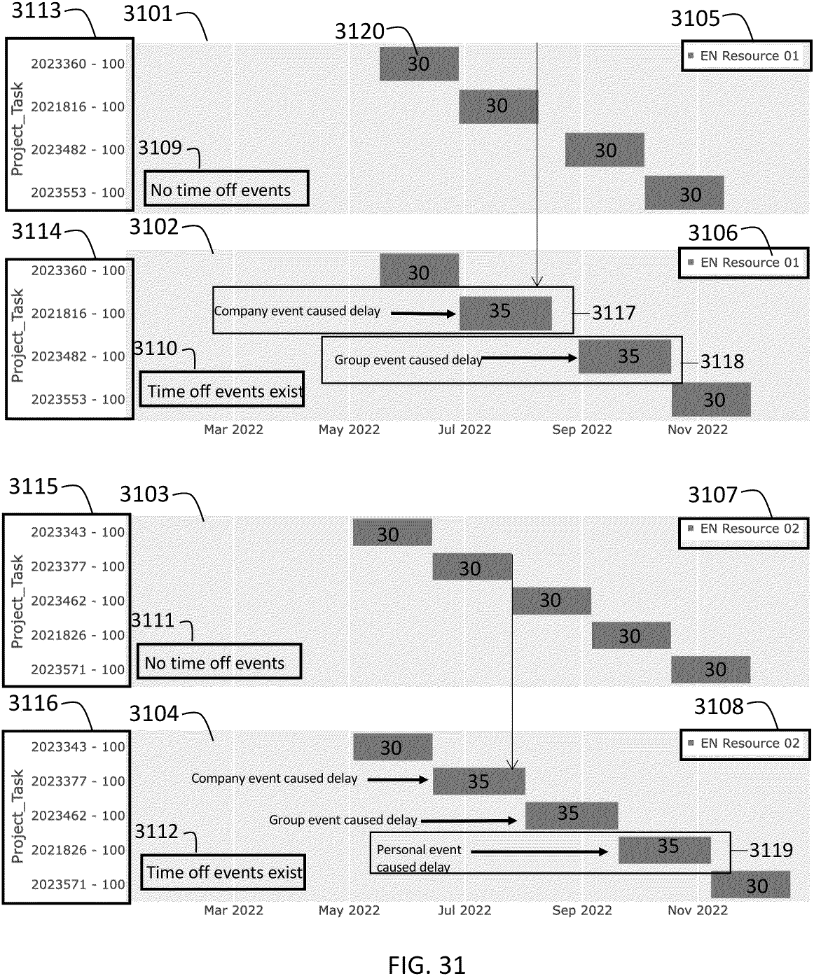

Since all three events listed in FIG. 29 impact the Engineering Group, it is easier to illustrate the impact of such events on resource allocations, by looking at the tasks assigned to the two resources in Engineering before and after events are recorded in the system, shown in FIG. 31.

FIG. 31 shows four Gantt charts 3101 - 3104. Gantt chart 3101 shows project tasks assigned to EN Resource 01 3105 before any events 3109. Gantt chart 3102 shows project tasks assigned to EN Resource 01 3106 with events 3110 as recorded in FIG. 29. Gantt chart 3103 shows project tasks assigned to EN Resource 02 3107 before any events 3111. Gantt chart 3104 shows project tasks assigned to EN Resource 02 3108 with events 3112 as recorded in FIG. 29. In the NPD process template, FIG. 2, on which all project plans in this example were built, Task 100 206 is assigned to Engineering 208, and it takes 30 days to complete 207. It is the only task in the project plan with Engineering ownership. Therefore, this task 100 in all nine projects are assigned to one of the two engineering resources EN Resource 01 or EN Resource 02.

Before the time off events, Task 100 in four of the projects are assigned to EN Resource 01 3113, and Task 100 in the remaining five projects, are assigned to EN Resource 02 3115. Task duration in workdays 3120 are listed for each task on the horizontal bars, representing the time period of the task in the Gantt charts. All of these tasks take 30 workdays to complete as indicated in FIG. 31, before time off events are recorded in the system. After the events are recorded in the system, dynamic resource allocations reflect the delays in completing some of the tasks, due to events impacting resource availability after the task start date. EN Resource 01, takes 35 workdays to complete one of the tasks 3117 due to the company shutdown for 5 days after the task start date, and 35 workdays to complete another task 3118 because of the Engineering Group Offsite meeting. Because of these delays, the timing of some of the tasks assigned to EN Resource 01 are also shifted in time in Gantt chart 3102, compared to the timing of the same tasks without the events in Gantt chart 3101. Similar effects are observed for tasks assigned to EN Resource 02, except that there is an additional impact of personal time off caused delay 3119. In this particular example, Task 100 being the last task in the critical path (see FIG. 16 and FIG. 21), no further tasks are impacted as a result of delays in Task 100. However, the company shut down for five days impacts all groups, and then through the task dependencies can impact timing of tasks for other groups. This interaction through dependencies can get complicated with more events, and more project tasks, and is spread over time.

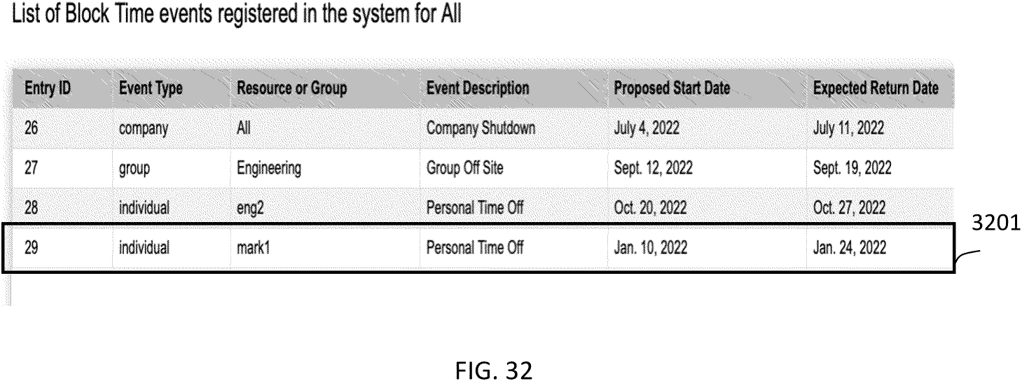

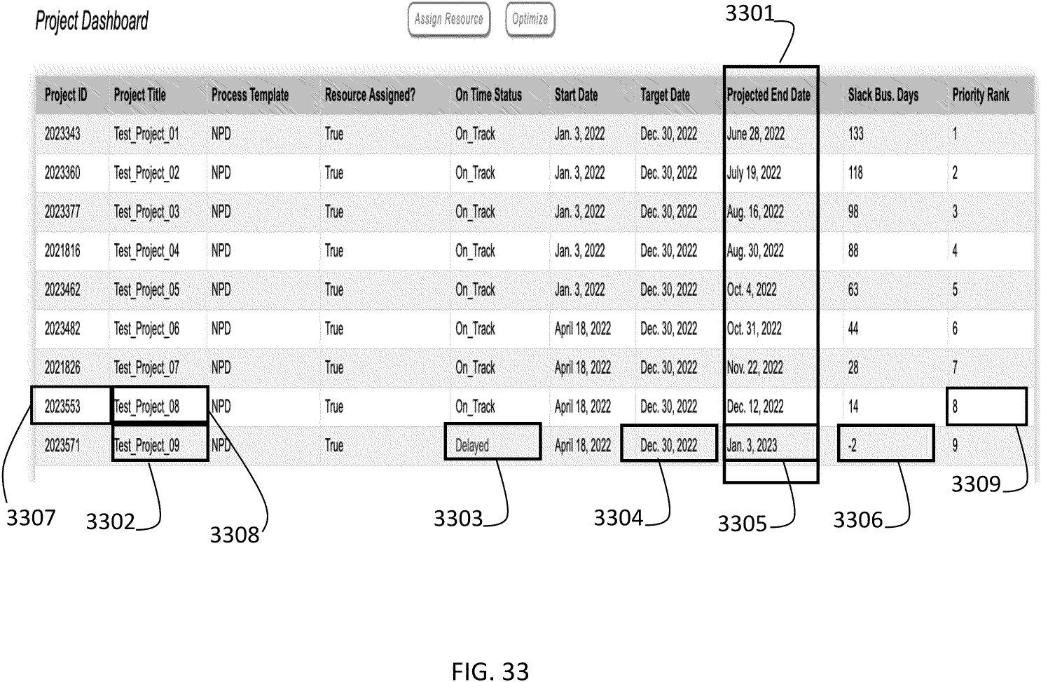

To further illustrate how interdependencies create complex interactions, a personal time off event was added to existing time off events in the system, as shown in FIG. 32. The resource in Marketing has a personal time off event for two weeks in January 2022, in this example 3201. Dynamic resource allocations were run, including this time off event 3201. FIG. 33 shows the resulting project completion dates 3301. Comparing the projected completion dates 3301 in FIG. 33, with the projected completion dates 3002 in FIG. 30 without the Marketing resource personal time off event, all projects are now delayed by the addition of this event. Test_Project_09 3302 is now projected to end on Jan. 3, 2023, 3305 past the target date of Dec. 30, 2022, 3304 resulting in a negative slack of 2 days for the project 3306, and a On Time Status that shows “Delayed” 3303.

We will now look at the project plans for Test_Project_08 3308, with and without the marketing resource time off event 3201, to understand the interactions. Test_Project_08 3308 has a project identification number of “2023553” 3307.

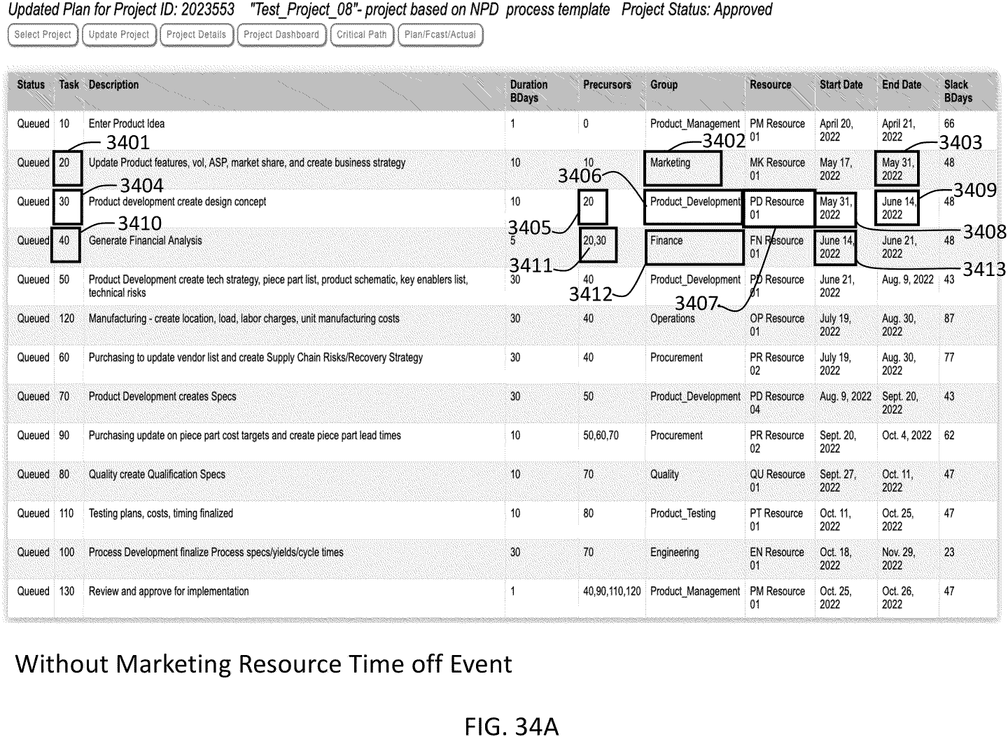

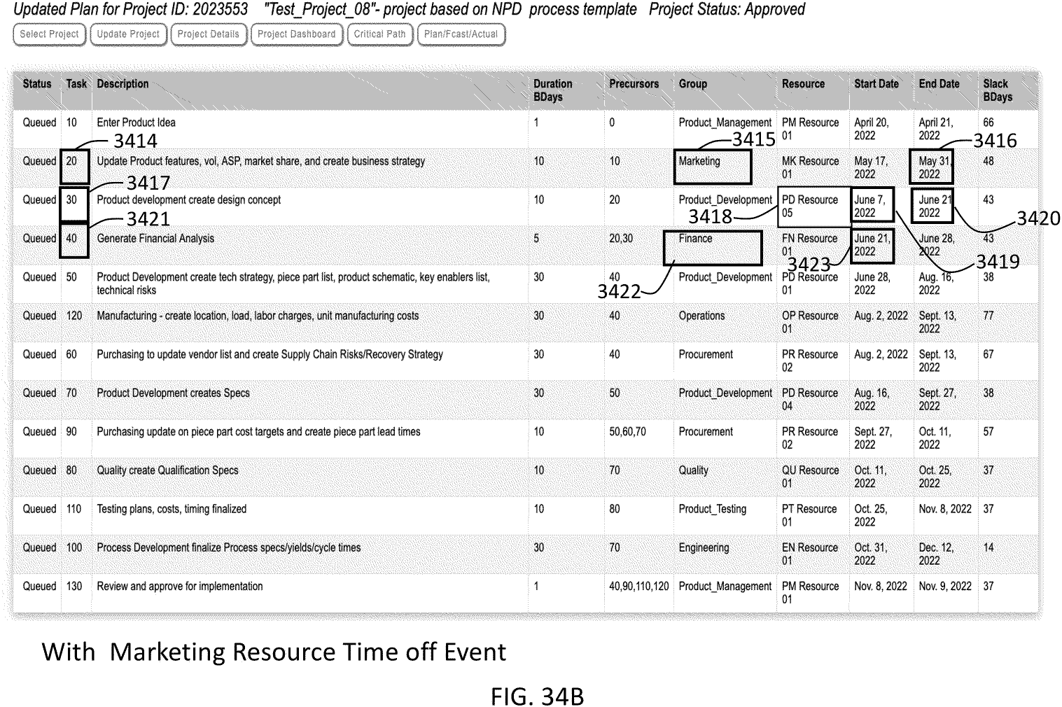

FIG. 34A shows the project plan for Test_Project_08 without the Marketing Resource personal time off event. Task 20 3401 belonging to Marketing 3402 is forecasted to complete on May 31, 2022, 3403. Task 30 3404 belonging to Product Development 3406 is dependent on completion of Task 20 3405. Task 30 starts on May 31, 2022, 3408, as expected, since Task 20 3401 ends on that day 3403. PD Resource 01 is assigned to this task 3407.

FIG. 34B shows the project plan for the same project with the Marketing Personal time off event 3201. Task # 20 3414 belonging to Marketing 3415 is also completed on May 31, 2022 3416, even with the Marketing Resource time off event. Since the Marketing Resource time off event occurred in January 2022, 3201 it did not impact the completion of the Marketing task in May 2022. However, the Marketing resource personal time off event in January had impacted the timing of tasks for Product Development resources, in other projects, such that, no Product Development resource is available to start Task 30 3417, until Jun. 7, 2022, 3419 causing a delay of 5 business days. Also, a different Product Development resource PD Resource 05 has been assigned this task 3418. Task 30 now ends on Jun. 21, 2022, 3420 reflecting the delay (compare with 3409 in FIG. 34A). This delay impacts the timing of subsequent project tasks assigned to different groups. For example, in FIG. 34A, without the Marketing resource time off event, Task 40 3410 assigned to Finance group 3412, is dependent on completion of tasks 20 and 30 3411 and starts on Jun. 14, 2022 3413, the same date that Task 30 is completed 3409. However, in FIG. 34B, with the Marketing resource time off event, Task 40 3421 assigned to Finance group 3422, now starts on Jun. 21, 2022 3423, reflecting the chain event of impact of the delay on other tasks and groups. Other tasks in the project plan are also similarly impacted. There are similar impacts in all other projects, as evidenced by the delayed project completion dates 3301 shown in FIG. 33.

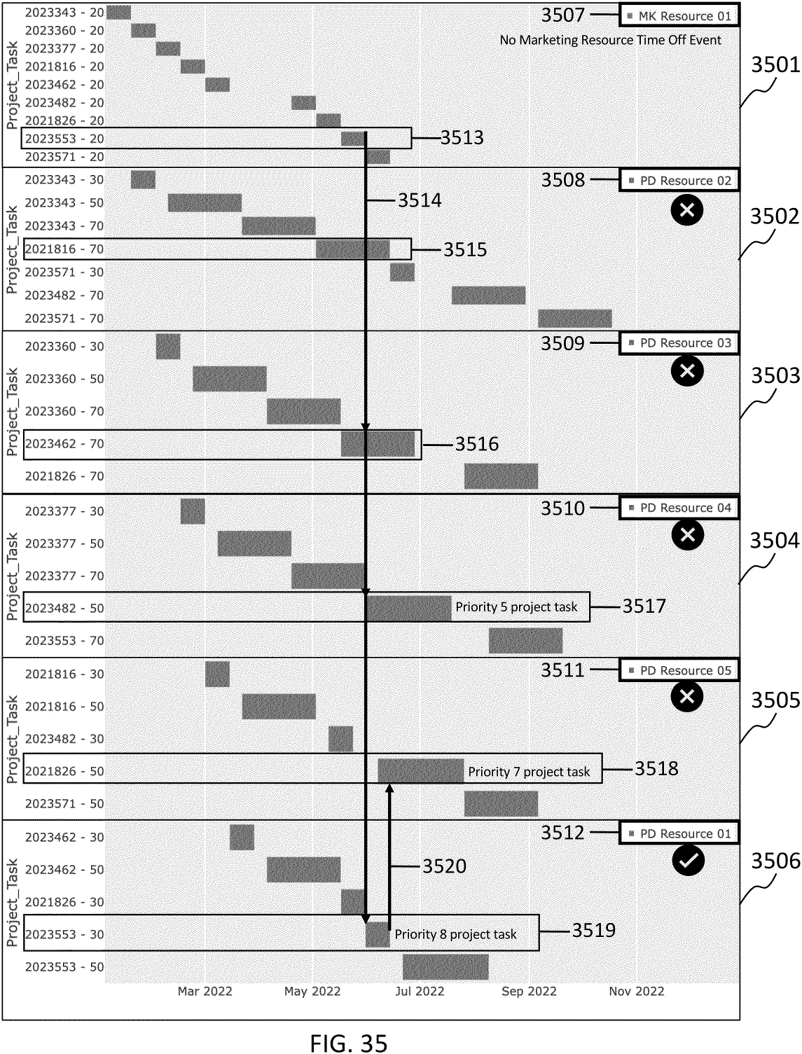

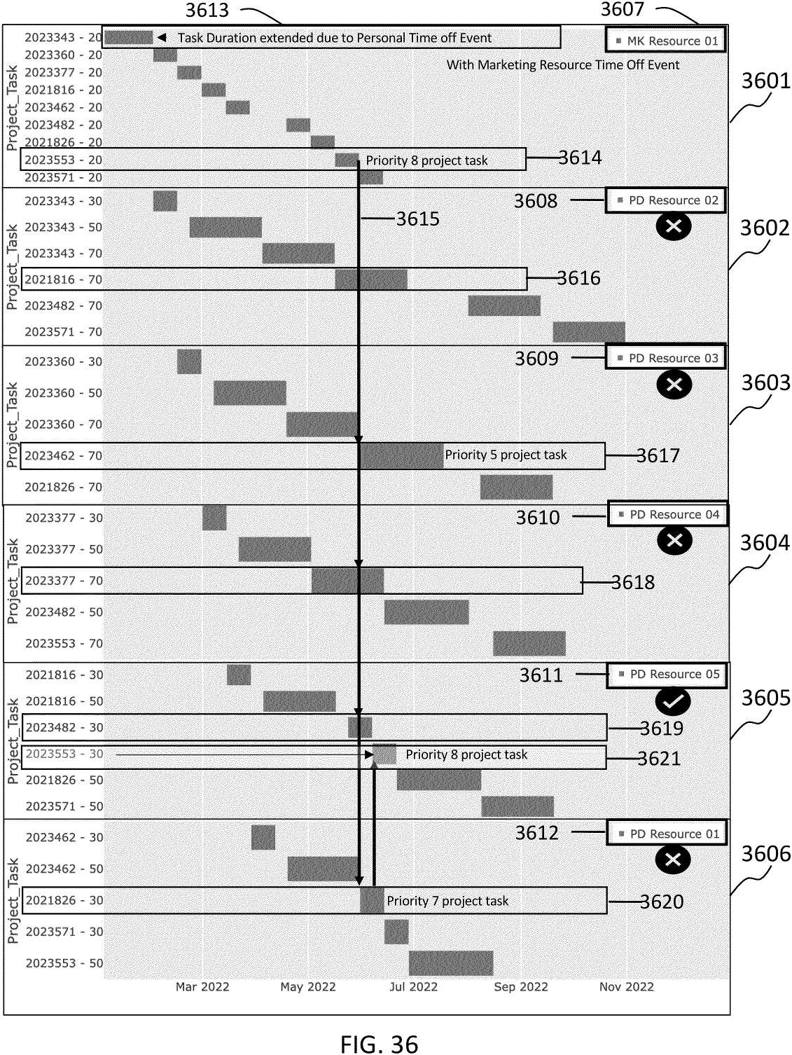

FIG. 35 and FIG. 36 illustrate how resource selections were made for the Task #30 in Test_Project_08 with and without the marketing resource time off, respectively. As stated earlier, the Product Development Resource assigned to this task changed from PD Resource 01 3407 to PD Resource 05 3418, when the Marketing Resource time off event 3201 was added. Test_Project_08 has a project priority number of 8 3309 which indicates a lower priority among the nine projects listed in FIG. 33. Project tasks derive their priority ranking from the project they belong to.

FIGS. 35 and 36 each consists of six Gantt charts of project tasks. The first Gantt chart of project tasks in FIGS. 35, 3501 and the first Gantt chart in FIG. 36 3601 show the project tasks assigned to the marketing resource MK Resource 01 3507 and 3607. The next set of five Gantt charts in FIG. 35 3502 - 3506 and in FIG. 36 3602 - 3606 show the project tasks assigned to each of the five Product Development Resources 3508 - 3512 and 3608 - 3612. The first observation comparing Gantt charts of tasks for Product Development Resources in FIG. 35 3502 - 3506 with the corresponding Gantt Charts on FIG. 36 3602 - 3606, is that the assignment of tasks to Product Development Resources has changed as a result of the Marketing resource time off event. This can be seen by simply observing changes to the number of horizontal task bars and their positions on the time scale in the charts for each of the Product Development resources. For example, compare Gantt Chart 3502 with Gantt Chart 3602, for PD Resource 02. There are seven horizontal bars in Gantt chart 3502, and only six horizontal bars in Gantt chart 3602, which indicates that PD Resource 02 has one less task assigned when the marketing resource time off event 3201 is added. The vertical down arrows 3514 in FIGS. 35 and 3615 in FIG. 36 mark the position of May 31, 2022, on the time axis (x-axis), as will be explained later. As we follow the down arrow and its intersection with horizontal task bars in Gantt charts 3503 - 3506, and compare it with Gantt charts 3603 - 3606, it is clear that the tasks have shifted in time for each of the Product Development resources. Also, comparing Gantt chart 3505 with Gantt chart 3605, it is clear that PD Resource 05 has an extra task assigned when the marketing resource time off event 3201 is added.

Task #30 3404 belonging to Product Development 3406 can only start upon completion of Task #20 3401 belonging to Marketing 3402. In FIG. 35 Task #20 in Test_Project_08 is identified as 2023553 - 20 (project identification - task identification) assigned to the marketing resource MK Resource 01 3513. The task is completed on May 31, 2022 3403. The vertical down arrow in FIG. 35 marks May 31, 2022 on the time axis 3514.

The dynamic resource allocation algorithm searches for an available resource to start Task 30 in Test_Project_08 on May 31, 2022. The sequence in which the algorithm checks on Product Development resource’s availability is, it checks availability of PD Resource 02 3508, then availability of PD Resource 03 3509, then availability of PD Resource 04 3510, then availability of PD Resource 05 3511 and finally availability of PD Resource 01 3512. This has to do with the sequence in which members were added in the system. As seen in FIG. 31, on May 31, PD Resource 02 is busy with another project task 3515, PD Resource 03 is also busy with another project task 3516, PD Resource 04 is assigned a higher priority task commencing on May 31 3517, and PD Resource 05 is assigned a higher priority project task starting after May 31 3518 but starting earlier than the forecasted end date for Task 30 in Test_Project_08, Jun. 14, 2022, 3520. Therefore, PD Resource 01 is assigned to Task 30 in Test_Project_08, identified on Gantt Chart 3506 as “2023553 - 30” 3519.

FIG. 36 shows the impact of the marketing resource time off event in January causing a delay in completion of a task assigned to MK Resource 01 3613 in Gantt chart 3601. This sets up a chain event impacting the assignment of tasks to Product Development resources shown in Gannt charts 3602 - 3606 which have changed as a result of the delay caused by the marketing resource time off event. This can be seen by comparing the number of horizontal bars in a chart and/or the location of those bars on the horizontal axis. For example, comparing Gantt chart 3602 with Gantt chart 3502 in FIG. 35, shows that PD Resource 02 has one fewer task assigned and timing of the tasks have shifted to the right, meaning later times, as a result of the marketing task delay 3613. Similarly, other Product Development resource task assignments are impacted as well. In FIG. 36, Task #20 in Test_Project_08 is identified as 2023553 - 20 (project identification -task identification) assigned to the marketing resource MK Resource 01 3614. The task is completed on May 31, 2022 3409, and there is no impact of the time off event in January on the task performed in May by the marketing resource.

However, as mentioned earlier, this event caused changes to Product Development resource task assignments, resulting in a different resource selection for task 30 in Test_Project_08, compared to FIG. 35. Once again, the vertical down arrow 3615 indicates the position of May 31, 2022 on the time axis. The dynamic resource allocation algorithm searches for an available resource to start Task 30 in Test_Project_08 on May 31, 2022. This time, PD Resource 02 is busy with another task 3616, PD Resource 03 is starting a higher priority task on May 31, 2022, 3617, PD Resource 04 is busy with another task 3618, PD Resource 05 is busy with another task 3619, and PD Resource 01 is assigned a higher priority task starting on May 31, 2022, 3620. Therefore, the dynamic resource allocation looks for the earliest available resource that can start Task 30 in Test_Project_08 after May 31, and that happens to be PD Resource 05 on Jun. 7, 2022 3621. Therefore, PD Resource 05 is assigned Task 30 in Test_Project_08, identified on Gantt Chart 3605 as “2023553 - 30” 3621. Likewise, every other task assignment in this project and other projects, and across different functional groups, are impacted in specific ways as a result of the dependencies and priorities.

This simple example illustrates a chain reaction of resource allocation changes and resulting project task timing changes and project delays, as a result of adding one marketing resource time off event. Imagine the complexity with multiple events and everyday changes impacting resource availability through complex interactions. The present invention is able to account for all such interactions and make appropriate resource allocations to project tasks and adjust project plans accordingly based on resource availability. It is very difficult to do this manually, and also to do it frequently, to keep up with changes.

Another example, for creating complex interactions, is when certain tasks are handled by a team of resources working together. The members of this team are also members of one or more functional groups and take on other individual project tasks. So, in some instances a resource works individually on a project task, and in other instances as part of a team of resources. During the time that a team is working on a project task, the team members are not available to start other tasks. On the other hand, if due to an earlier individual task assignment, a team member is not available for a portion or all of the duration of a team task, the team task can commence as long as there is at least one team member available to start the task, but it will take longer to complete the task, since the full team cannot work on it completely.

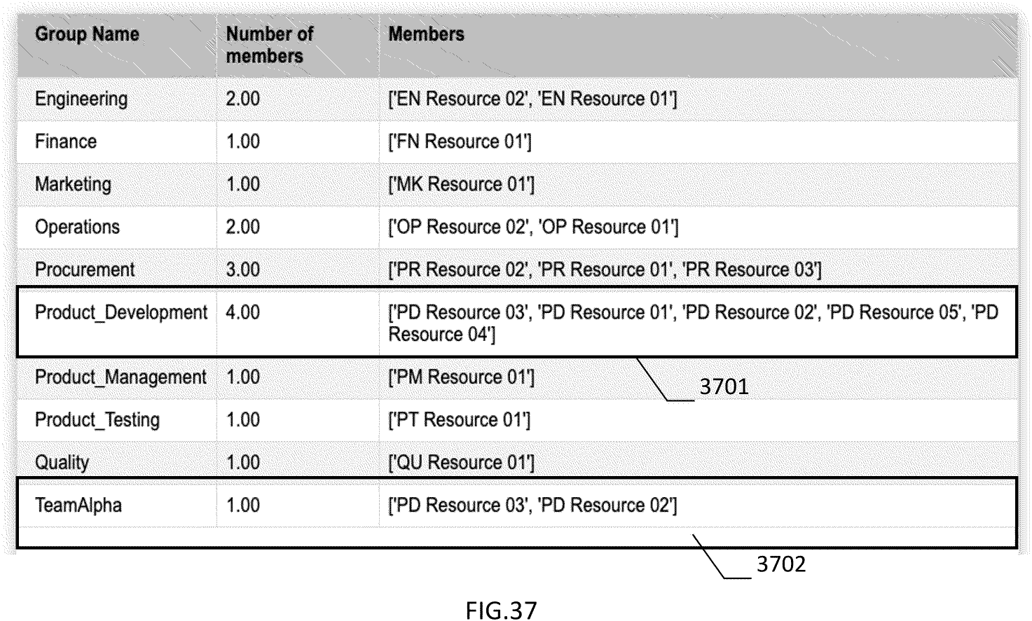

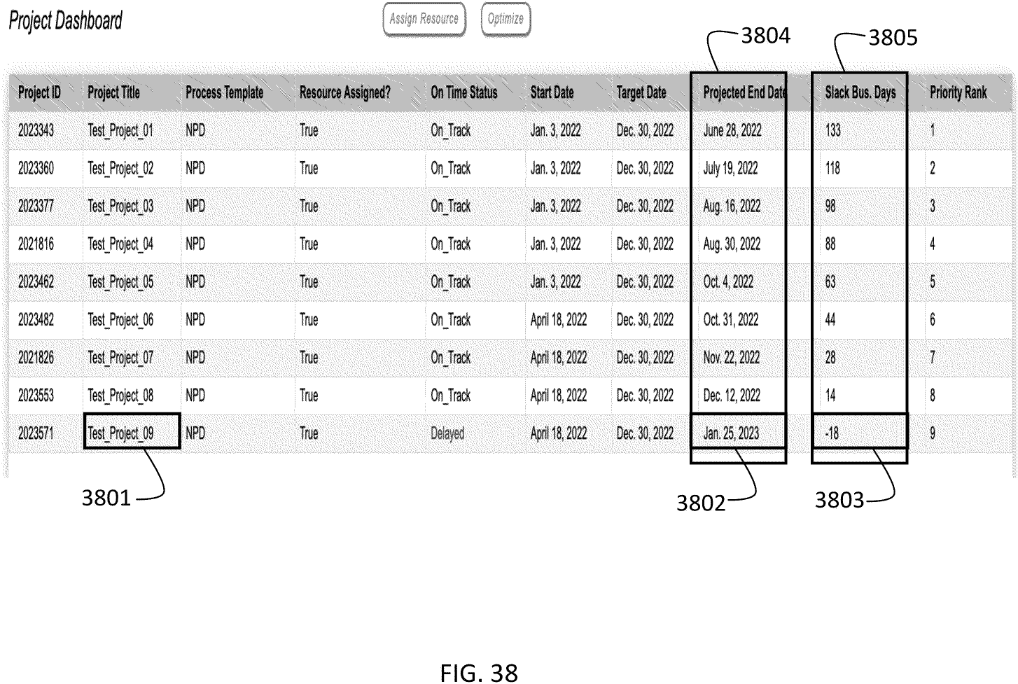

To illustrate this example, two members of Product Development were also made members of a team called “TeamAlpha”. FIG. 37 shows the new organization of resources. Resources PD Resource 02 and PD Resource 03 are now shared between TeamAlpha 3702 and Product Development 3701. Task #30 in the Project Plan, which was assigned to Product Development, was assigned to this new team, in all nine projects. With these changes made, resource allocations were run for the nine projects. FIG. 38 shows the resulting Project Dashboard after the resource allocations, for the “reduced staff + deferred project starts” scenario, with the new team, and the time off events registered in the system FIG. 32. Projected end date 3802 for Test Project_09 3801 is further delayed compared to the projected end date without the team tasks 3305 in FIG. 33, resulting in an even more negative project slack of -18 business days 3803 compared to the project slack of -2 business days without the team tasks 3306 in FIG. 33.

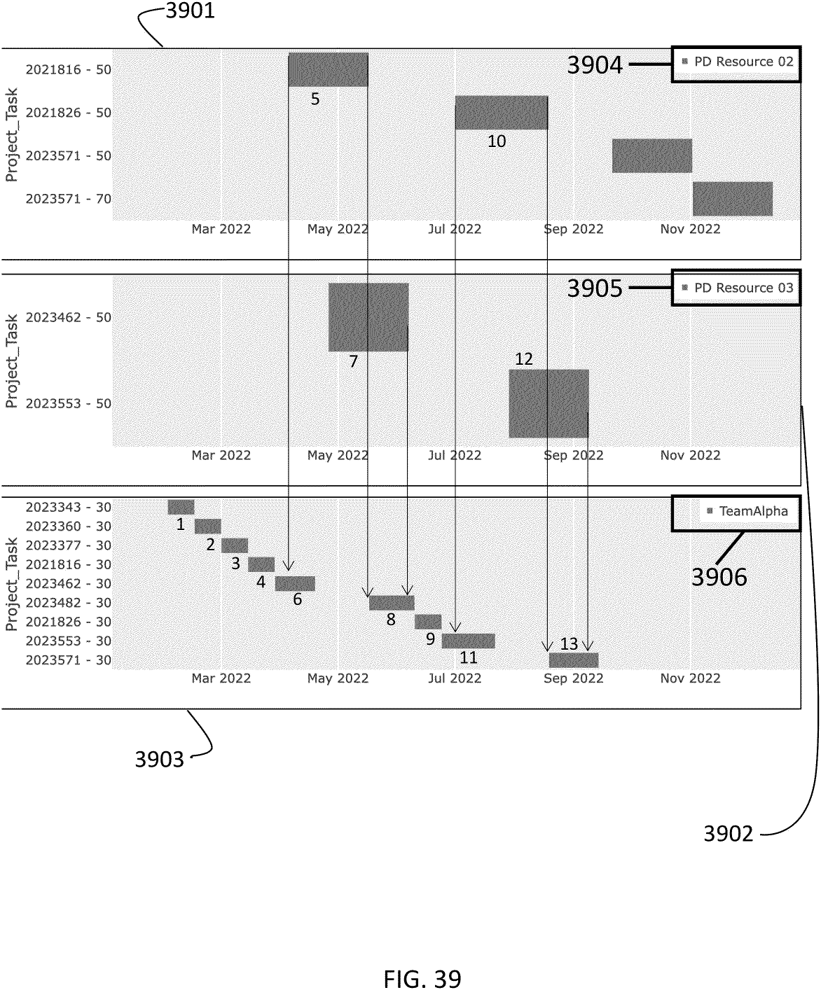

The task load on TeamAlpha is shown in FIG. 39, which highlights the complex interactions between individual assignments, team assignments, and time off events. FIG. 39 consists of three Gantt charts 3901 - 3903. Gantt chart 3901 shows the individual tasks assigned to PD Resource 02 3904, as a member of Product Development group. Gantt chart 3902, shows the individual tasks assigned to PD Resource 03 3905, as a member of Product Development group. Gantt chart 3903 shows the team task assigned to TeamAlpha 3906, whose members are PD Resource 02 and PD Resource 03. We will now step through the interactions between team assignments, individual assignments, and time-based events impacting resource availability, that determine the timing and duration of project tasks, and therefore the project plans. The step numbers listed here are also listed on FIG. 39:
1. Project 2023343, Task 30, (Test_Project_01, with priority 1) is assigned TeamAlpha, team assignment
2. Project 2023360, Task 30, (Test_Project_02, with priority 2) is assigned TeamAlpha, team assignment
3. Project 2023377, Task 30, (Test_Project_03, with priority 3) is assigned TeamAlpha, team assignment
4. Project 2021816, Task 30, (Test_Project_04, with priority 4) is assigned TeamAlpha, team assignment
5. Project 2021816, Task 50, (Test_Project_04, with priority 4) is assigned PD Resource 02, individual assignment to Product Development resource
6. Project 2023462, Task 30, (Test_Project_05, with priority 5) is assigned TeamAlpha, team assignment, its duration is extended because one of the team members, PD Resource 02 is not fully available to work on this team task
7. Project 2023462, Task 50, (Test_Project_05, with priority 5) is assigned PD Resource 03, individual assignment to Product Development resource
8. Project 2023482, Task 30, (Test_Project_06, with priority 6) is assigned TeamAlpha, team assignment, its starting date is pushed out, till one of the resources, PD Resource 02, becomes available to start the task, and its duration is extended because one of the team members, PD Resource 03 is not fully available to work on this team task
9. Project 2021826, Task 30, (Test_Project_07, with priority 7) is assigned TeamAlpha, team assignment
10. Project 2021826, Task 50, (Test_Project_07, with priority 7) is assigned PD Resource 02, individual assignment to Product Development resource, its duration is extended by 5 days, because of the company time off event 2906 (see FIG. 29) between July 4 and July 11 of 2022.
11. Project 2023553, Task 30, (Test_Project_08, with priority 8) is assigned TeamAlpha, team assignment, but its duration is extended because one of the team members, PD Resource 02 is not fully available to work on this team task
12. Project 2023553, Task 50, (Test_Project_08, with priority 8) is assigned PD Resource 03, individual assignment to Product Development resource
13. Project 2023571, Task 30, (Test_Project_09, with priority 9) is assigned TeamAlpha, team assignment, its starting date is pushed out, till one of the resources, PD Resource 02, becomes available to start the task, and its duration is extended because one of the team members, PD Resource 03 is not fully available to work on this team task

The present invention accounts for the complexity and impact of such interactions to ensure that no resource is double booked at any time period, no resource is booked beyond the defined daily maximum hours of project work, no resource is booked on defined weekends and holidays, to complete assignments, and sufficient time is provided to account for forecasted delays as seen in the example above.

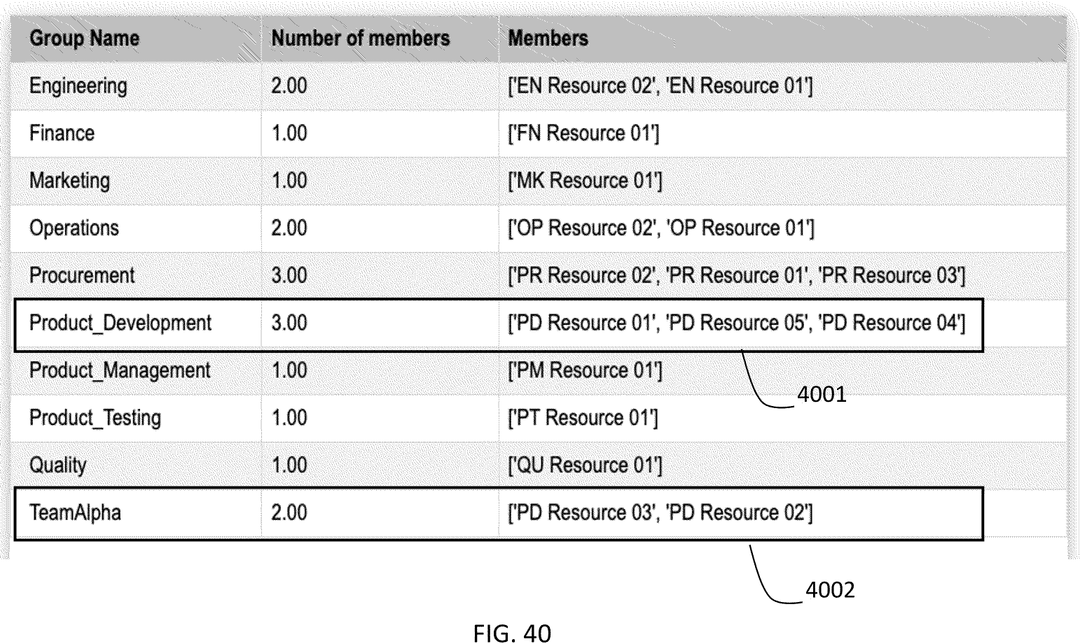

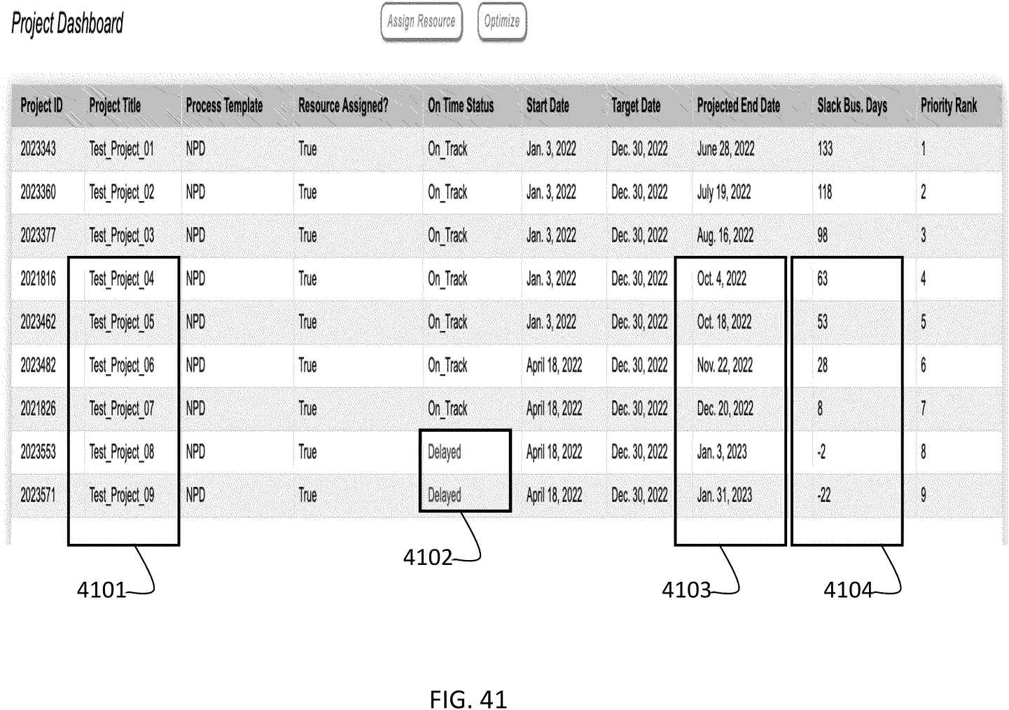

An interesting experiment is to see what happens if resources PD Resource 02 and PD Resource 03 are fully dedicated to TeamAlpha tasks, and not shared to cover Product Development group tasks. FIG. 40 shows organization of resources for this scenario. PD Resource 02 and PD Resource 03 are no longer part of the Product Development group 4001. They are exclusively members of TeamAlpha 4002. FIG. 41 shows outcome of the resource allocations on Project completion dates for the “reduced staff + deferred project starts” scenario, with the events shown in FIG. 32 impacting resource availability, and creation of a team “TeamAlpha” with two resources moved (not shared) from Product Development group to TeamAlpha 4002. This change in organization of resources, impacted 6 of the 9 projects with more delays. Test_Project_04 to Test-Project_09 4101 are now projected to complete even later 4103 compared to the scenario where the resources were shared between Product Development and TeamAlpha 3804 in FIG. 38. Correspondingly, the project slacks 4104 for these projects are lower compared to the project slacks 3805 when resources were shared. Test_Project_08 now shows a On Time Status of “Delayed” 4102 along with Test_Project_09.

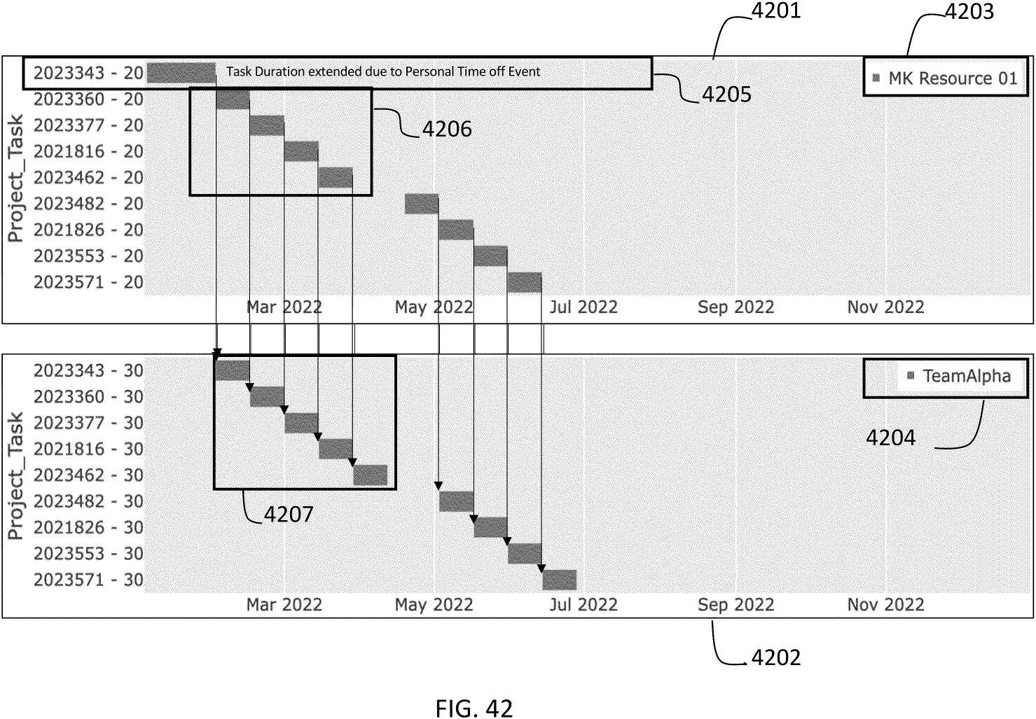

The distribution of tasks for TeamAlpha is shown in FIG. 42. FIG. 42 has two Gantt charts 4201 and 4202 of project task assignments to the marketing resource MK Resource 01 4203 and TeamAlpha 4204. Both Marketing and TeamAlpha have one task each in each of the nine project plans. Marketing owns Task 20 as we have seen before. TeamAlpha has Task 30 that used to be owned by Product Development before. As we have seen before, Task 30 cannot start till Task 20 is completed. The Marketing time off event in January 2022, does delay one of the tasks 4205, and shifts a few of the other marketing tasks to the right, that is later times, 4206 in the Gantt chart 4201. As a result, some of the TeamAlpha tasks that depend on completion of corresponding marketing task in the project are also shifted in time to the right 4207 in Gantt chart 4202. Because the TeamAlpha resources are not shared with Product Development, interactions seen in FIG. 39 with Product Development tasks are eliminated.

The examples presented demonstrate that dependencies of tasks on completion of other tasks, and dependencies of tasks on resources with specific skill sets and knowledge, result in complex interactions that manifest in different ways over time in different projects due to resource availability constraints. It is not easy to envision and account for them manually. The present invention accounts for such interactions and ensures project plans are constructed based on resource availability and updated frequently to keep up with the impact of changes on resource availability.

It is to be understood that the term “project” as used throughout the following discussion can be basically defined as a collection of “tasks”. In one example, the collection of tasks can be performed by one or more functional groups, to accomplish a specific business objective, for example but not limited to, designing, developing and launching new products, approving and onboarding a supplier, qualifying production and assembly processes, facilities or products, constructing buildings, highways, onboarding a customer and the like. Additionally, the term “project” can be used in accordance with the purposes of the present invention to describe a collection of “service request tasks” including, but not limited to, lab and testing services, production support, customer support, supplier support, maintenance work, facilities management, analysis requests of various kinds, setting up specific systems or computer programs. Indeed, it is to be understood that the principles of the present invention can be directed to a different collection of tasks for any suitable purpose others than those specifically identified above.

Regardless of the specific application, each “project” has a defined priority to it, a start date, and a desired target date for completion. Specifically, all tasks within a project also need to be completed and closed for a given project to be completed. New tasks can be added to a project and existing tasks can be deleted, and existing tasks can be modified as well. Various ones of the critical attributes of a project, as well as a task within a project, are shown in FIGS. 7 and 9, respectively. More attributes may be added to a project record or task record, as required.

It should be understood that the methods, features, devices and systems disclosed herein are merely exemplary embodiments of the invention. One of ordinary skill in the art will appreciate that changes and variations to the disclosed embodiments may be made without departing from the spirit and scope of the inventions as set forth in the appended claims.

What is claimed is:

1. A system for dynamically allocating resources to project tasks without conflicts with other project tasks and events, and deriving project plans from such dynamic allocation of resources, the system comprising:
a computer with internet connection;
a web browser;
a web-based platform to enter and update information on resources, projects, tasks, resource groups, process templates; to view the outputs of dynamic resource allocations, in the form of resources assigned project plans across all projects, resource utilization, resource loads, group loads; and
a computing module for performing an algorithm that alone allocates resources to project tasks, and updates project plans with specific resource allocation and timing for each task on a scheduled basis, to ensure that no resource is double booked at any time period, no resource is booked beyond the defined daily maximum hours of project work, no resource is booked on defined weekends and holidays, and sufficient time is provided to account for expected delays in completing tasks as calculated by the algorithm.

2. The system of claim 1 wherein an event is selected from the list consisting of tasks, assignments, company events, group events, and personal events, which make one or more resources unavailable at specific times and for specific periods of time.

3. The system of claim 1 wherein the web-based platform is configured to enable the addition of new resources.

4. The system of claim 1 wherein the web-based platform is configured to enable the addition of new groups.

5. The system of claim 1 wherein the web-based platform enables creating new projects and building plans or altering plans for projects.

6. The system of claim 1 wherein the web-based platform is further configured to allow adding, deleting, or modifying project tasks; each project task as a minimum consists of a task id, a list of precursor task ids, description, duration, effort in hours, and a group ownership for the task to base the resource selection from.

7. The system of claim 1 wherein the computing module always allocates resources to all tasks across all projects each and every time to ensure that it is coordinated to avoid conflicts with other tasks and events, and minimize delays from events interfering with resource availability after task start date.

8. The system of claim 1 the use of the web-based platform for publishing and updating project plans that are always integrally linked to and based on dynamic allocation of resources from start to finish of all projects, such dynamic resource allocations being done by an algorithm within the computing module to ensure no conflicts and minimum delays to all project tasks.

9. The system of claim 1 that performs such dynamic resource allocations as a minimum at least once a day across the entire set of projects to keep up with the impact of all changes and adjust the resource allocations and project plans in real time.

10. The system of claim 1 for continually monitoring changes in organizational resources, groups, projects, tasks, priorities, and deadlines, and dynamically adjusting allocations to avoid conflicts and minimize delays while maintaining the requested priorities.

11. The system of claim 1 that accounts for company events and holidays, weekends, group events, personal events and vacations, special assignments, while allocating resources to project tasks, to avoid conflicts and minimize delays, thus reflecting the impact of all such events on resulting resource allocations and resulting project plans.

12. The system of claim 1 wherein the web-based platform is further configured to move resources to different functional groups, add or remove resources from a group, create a new functional group, add temporary resources to a group, that would result in different resource allocations and project plans for the desired objective.

13. The system of claim 1 wherein the web-based platform is further configured to allow for each resource to be shared across multiple groups and/or teams for project tasks or special assignments or initiatives, and account for all such associations while dynamically assigning resources to all future tasks, avoiding conflicts, and minimizing delays on the resulting project plans.

14. The system of claim 1 that allows for a task to be assigned to a team of resources, and for those resources to be treated as a single entity for the duration of that team assignment, making them unavailable for other assignments during the time period of team assignment.

15. The system of claim 1 wherein the computing module is configured to compute the resource loads and resource utilization statistics for any time period on a function group, team, or an individual resource or for all resources and groups, for any given project or set of projects based on the outcome of dynamic resource allocation.

16. The system of claim 1 wherein the computer module is configured to project resource loads required in future time periods, based on dynamic resource allocations, for resource planning.

17. The system of claim 1 wherein the computer module is further configured to highlight resource induced delays in each project, which will provide insights on time, type, and number of resources needed to eliminate the delays.

18. The system of claim 1 wherein the web-based platform is further configured to modify input parameters such as project priorities, project start dates, task durations, and resource numbers in different functional groups to achieve different scenarios of resource allocations that yield different project plans to meet desired objectives such as maximizing resource utilization across existing resources, or minimizing project delays, or ensuring all projects can be completed within a given time period or other scenarios.

19. The system of claim 1 wherein the web-based platform is further configured to modify project task durations and efforts, task dependencies, task group assignments, add or delete tasks, and therefore alter the dynamic resource allocations to yield desired project plans.

20. The system of claim 1 wherein the web-based platform is configured to import, create, modify, process templates that can be used to create new projects and then dynamically assign resources to the new project in conjunction with all other existing projects to ensure all project plans are based on resource availability for specific times and specific resources to execute the plans.

21. The system of claim 1 wherein the web-based platform is configured to update project start dates, target dates, priorities, cancel project, put projects on hold, reactivate on-hold projects, or complete projects so as to facilitate new dynamic resource allocations and project plans for all approved or active projects.

22. The system of claim 1 wherein the computing module is configured to automatically detect delays to projects from overdue tasks and adjust resource allocations and project plans to reflect the impact of delays.

23. The system of claim 1 that automatically opens up dependent tasks to assigned resources for action, when a task is completed.

24. The system of claim 1 wherein the web-based platform is configured to define the work week, that is which days of the week are working days, and the number of workhours each workday, for the company, group, or individual resources.

25. The system of claim 1 wherein the web-based platform is configured to define different administrative groups with different access privileges.

26. The system of claim 1 to dynamically manage human resource allocations for all planned activity and standard work tasks in an organization.

27. The system of claim 1 wherein the web-based platform is configured to create resource and group billing summaries for any time period.

28. The system of claim 1 configured to integrate suppliers, collaborators, and customers in project plans or other planned activity through dynamic resource allocations based on availability of the supplier, collaborator, or customer resources to complete required tasks without conflict.

29. The system of claim 1 wherein the use of the web-based platform for publishing and updating project costs that are always integrally linked to and based on dynamic allocation of resources from start to finish of all projects, such dynamic resource allocations being done by an algorithm within the computing module to ensure no conflicts and minimum delays to all project tasks.

30. The system of claim 1 wherein the web-based platform is further configured to modify input parameters such as project priorities, project plans, project start dates, and resource numbers in different functional groups to achieve different scenarios of resource allocations, project plans, and corresponding project costs to meet desired cost objectives.
